(19) United States
(12) Patent Application Publication
(10) Pub. No.: US 2003/0218537 A1
(43) Pub. Date: Nov. 27, 2003

(54) Interactive modular system

(75) Inventors: David Hoch, Watertown, MA (US); Andrew Kennedy Lang, Sherborn, MA (US)

Correspondence Address: LAHIVE & COCKFIELD, 28 STATE STREET, BOSTON, MA, 02109, US

(73) Assignee: Lightspace Corporation, Watertown, MA (US)

(21) Appl. No.: 10/285,342

(22) Filed: Oct. 30, 2002

Related U.S. Application Data
(60) Provisional application No. 60/382,511, filed on May 21, 2002.

(51) Int. Cl. G08B 25/00; G09B 7/00

(52) U.S. Cl. 340/524; 434/323

(57) ABSTRACT

A system and method are provided for interacting one or more individuals. The apparatus and method allow a playing surface to interact with a user or a physical object. The physical object is associated with goods suitable for use with the system, such as balls, foot ware, racquets and other suitable goods. The system is capable of tracking each user and tracking each physical object. The system is illuminable in a spectrum of colors under control of a computer. The computer can control the illumination of the system based in part on detected movement or predicted movement or both, of a user and of a physical object. Moreover, the system provides a number of pressure sensitive surfaces to detect and track a user. The system is suitable for placement on a floor, a ceiling, and one or more walls or any combination thereof.

### TECHNICAL FIELD OF THE INVENTION

The present invention generally relates to a lighting system, and more particularly, to an interactive modular system that interacts with the users.

### BACKGROUND OF THE INVENTION

There are a number of different illuminable entertainment and amusement systems in use today that utilize sensory stimuli, such as sound and lights, to entertain and interact with a user. An example of such a system is a lighted dance floor or a video game system found in an entertainment complex. Unfortunately, these amusement and entertainment systems found in an entertainment complex are of a fixed dimensional size. Consequently, the installation and removal of these amusement systems are burdensome and costly.

In addition, the conventional amusement or entertainment system is limited in its ability to interact with the user. For example, a typical lighted dance floor provides little, if any interaction with the user. The dance floor provides a preset visual output controlled by a disc jockey or lighting effects individual or coordinated to a sound output.

Moreover, video game systems currently available from various manufacturers, such as Microsoft®, Sega®, Sony® and the like are also limited in their ability to interact with the user. For example, the number of users is limited, each user must use a hand-held controller to interact with the video game system.

Although entertainment and amusement systems in entertainment complexes are more interactive than illuminated dance floors, they rely upon pressure sensors in a floor portion to sense and track the user. As such, conventional entertainment and amusement systems are reactive to the user and are unable to detect in which direction a user is heading as they step onto another segment of the floor portion and how quickly the user is heading in that particular direction. Moreover, the entertainment and amusement systems typically found in entertainment complexes are of a limited size that places a significant limit on the number of users that can interact with the system. As a consequence, conventional entertainment and amusement systems lack the ability to determine a possible future location of a user, a portion of a user, or a physical object as they are moved or positioned on or above the floor.

### SUMMARY OF THE INVENTION

The present invention addresses the above-described limitations by providing a modular system that is adaptable to a physical location and provides an approach for the system to sense and track a user, or physical object, even if the user is not standing on a modular floor element of the system. The present invention provides an interactive modular system that includes the ability to sense and predict a direction in which a user is moving without the need for pressure like sensors in a modular floor element of the system. In addition, the present invention, due to a plurality of modular illuminable assemblies, allows for system relocation from a first physical location to a second physical location without need to modify either physical location.

According to one embodiment of the present invention, a system for entertaining one or more users is provided having a physical object capable of transmitting data to, and receiving data from a portion of the system. The system also provides an electronic device for controlling operation of the system. Operation of the illuminable system is based in part on the data transmitted by the physical object. Furthermore, a modular illuminable assembly is provided and is in communication with the electronic device and the physical object. The modular illuminable assembly provides the electronic device with the data transmitted by the physical object and responds to data provided by the electronic device for the entertainment of one or more users.

The above-described approach allows the system to be moved from a first physical location to a second physical location with a minimum amount of time and expense. Moreover, this approach allows the system to be adapted to multiple physical locations of various size and shape. For example, the system can be configured for use as an aerobic work out system in a health club, or as a dance floor in a nightclub or as gaming system that covers the entire field portion of a stadium complex. As such, the system is configurable to a number of different shapes and sizes. Moreover, the physical object is typically associated with a user, thus allowing the system to identify and track each user without the need for the user to step onto a floor element of the system. As a result, the system is able to act in a proactive manner to sense where each user and each physical object is located in the system and, in turn, the system is capable of predicting a future location of a particular user and interact with the selected user to provide a heightened entertainment environment.

In accordance with another aspect of the present invention, a method is performed for entertaining an individual. The method includes the step of receiving data from a physical object in a wireless manner to determine a position of the physical object. Finally, one or more illumination sources are illuminated based on the position of the physical object. The illumination of the one or more illumination sources can be based in part in the position of the physical object and in part on the scheme or type of entertainment being provided.

The above-described approach benefits an entertainment system that utilizes a physical object such as a ball, racquet or other similar sporting goods to entertain a user. The approach allows for one or more illumination sources to be illuminated based on a current location of the physical object, a predicted future location of the physical object or both. Accordingly, the illumination sources can form a trail of light as the physical object passes over or can form a light path that indicates to the user a direction for the physical object to travel. For example, if the individual throws or hits a ball containing the physical object, then one or more illumination sources can be lighted with a variety of colors and intensities to indicate the trajectory of the physical object. As such, the illumination sources can be controlled and illuminated in multiple manners in response to a current position or predicted position of the physical object. In this manner, the individual is provided with the ability to more closely interact with the entertainment system to increase their overall entertainment experience.

In yet another embodiment of the present invention, a movement transducer is provided that provides a response to a physical stimulus, the response indicating a velocity of the movement transducer. The movement transducer includes a sensor circuit to sense the physical stimulus and a control circuit to control operation of the sensor. The control circuit is capable of communicating with an electronic device to communicate the sensor's response to the physical stimulus.

The above-described invention benefits an entertainment or amusement system capable of interacting with a user. The movement transducer can be a physical object that is attachable to the user or integrated into a number of goods for use with the entertainment or amusement system. Examples of goods suitable for use with the system include footwear, clothing, or sporting goods. As a result, the entertainment or amusement system can be enhanced to track one or more users on an individual basis, or one or more goods. Consequently, the enhanced entertainment or amusement system can detect a current location of each user or each good without the need for pressure sensors. Furthermore, the enhanced system can predict a future location of each user or goods to provide an entertainment or amusement system that heightens the entertainment environment of the user.

According to still another embodiment of the present invention, a method is provided for controlling operation of a physical object that is capable of providing a sensory stimulation to a human being. The physical object communicates with an electronic device in a wireless manner. A first data set is transmitted from the physical object to the electronic device. The first data set indicates an acceleration value of the physical object in at least one of three axes, for example, axes an X-axis, a Y-axis and Z-axis. Finally, the electronic device transmits a second data set to the physical object. The second data set provides the physical object with instructions to enable the physical object to generate an output that provides the sensory stimulation to the human being. The data in the second data set is based in part on data transmitted in the first data set in order to provide the sensory stimulation to the human being. Optionally, the physical object is capable of detecting its own location and transmitting data that indicates the location of the physical object.

The above-described approach allows an entertainment or amusement system to interact with a physical object in a wireless manner in order to provide a user with an enhanced sense of interacting with the system. The method allows the user to sense a sensory stimulation, such as an audio, visual or vibrational stimulus to maximize the user's interaction with the system. As such, a system may randomly select various users in a game of tag to assign the selected user the label “it”.

In still another embodiment of the present invention, an apparatus for providing a sensory stimulus to an individual is provided. The apparatus includes an electronic assembly capable of generating the sensory stimulus. The electronic assembly communicates with one or more electronic devices to control generation of the sensory stimulus. Moreover, the electronic assembly is capable of supporting the weight of an individual to allow the individual to step onto and off of the electronic assembly.

### BRIEF DESCRIPTION OF THE DRAWINGS

An illustrative embodiment of the present invention will be described below relative to the following drawings.

FIG. 1 depicts a block diagram of a system suitable for practicing the illustrative embodiment of the present invention.

FIG. 2 illustrates an exemplary configuration of a system suitable for producing an illustrative embodiment of the present invention.

FIG. 3 depicts a flow diagram illustrating steps taken for practicing an illustrative embodiment of the present invention.

FIG. 4 illustrates a block diagram of an illuminable assembly suitable for practicing the illustrative embodiment of the present invention.

FIG. 5 illustrates a block diagram of an illuminable assembly suitable for practicing the illustrative embodiment of the present invention.

FIG. 6 is a block diagram suitable for use with the illuminable assembly illustrated in FIG. 4 or 5.

FIG. 7 is a block diagram of a pixel suitable for use with the illuminable assembly illustrated in FIG. 4 or 5.

FIG. 8 is a block diagram of a receiver suitable for us with the illuminable assembly illustrated in FIG. 4 or 5.

FIG. 9 is a block diagram of a speaker suitable for use with the illuminable assembly illustrated in FIG. 4 or 5.

FIG. 10 is a block diagram of a pressure sensory suitable for use with the illuminable assembly illustrated in FIG. 4 or 5.

FIG. 11 is a block diagram of a physical object suitable for practicing an illustrative embodiment of the present invention.

FIG. 12 is a flow diagram illustrating steps taken for communication with a physical object suitable for practicing an illustrative embodiment of the present invention.

FIG. 13 is a block diagram of a controller suitable for use with the physical object illustrated in FIG. 11.

FIG. 14 is a block diagram of a first interface circuit suitable for use with the controller illustrated in FIG. 11.

FIG. 15 is a block diagram of a second interface circuit suitable for use with the controller illustrated in FIG. 11.

FIG. 16 is an exploded view of the illuminable assembly illustrated in FIG. 4.

FIG. 17 is a bottom view of the top portion of the illuminable assembly illustrated in FIG. 16.

FIG. 18 is a side view of a pixel housing suitable for use with the illuminable assembly depicted in FIG. 16.

FIG. 19 is a prospective view of a reflective element suitable for use with a pixel housing of the illuminable assembly depicted in FIG. 16.

FIG. 20 is a bottom view of a mid-portion of the illuminable assembly depicted in FIG. 16.

FIG. 21A is a block diagram of transmitters on a physical object.

FIG. 21B is a block diagram of the patterns formed by the receivers on the modular illuminable assembly that are receiving signals from the transmitters depicted in FIG. 21A horizontally oriented to the modular illuminable assembly.

FIG. 22 is a flowchart of the sequence of steps followed by the illustrative embodiment of the present invention to determine the position and orientation of the physical object relative to the modular illuminable assembly.

### DETAILED DESCRIPTION

The illustrative embodiment of the present invention provides an interactive modular system that interacts with a user by communicating with the user in a wireless manner. The system based on the communications with the user generates one or more outputs for additional interaction with the user. Specifically, the interactive modular system detects and tracks each user or physical object as a distinct entity to allow the system to interact with and entertain each user individually. As such the system utilizes a number of variables, such as the user profile for a specific user, a current location of each user, a possible future location of each user, the type of entertainment event or game in progress and the like, to generate one or more effects to interact with one or more of the users. The effects generated by the system typically affect one or more human senses to interact with each of the users.

In the illustrative embodiment, the interactive modular system includes at least one physical object associated with each user and one or more modular illuminable assemblies coupled to form an entertainment surface. Each physical object communicates with at least a portion of the one or more modular illuminable assemblies. The physical object and the modular illuminable assembly are capable of providing an output that heightens at least one of the user's physical senses.

According to one embodiment, the present invention is attractive for use in a health club environment for providing aerobic exercise. The system of the present invention is adapted to operate with a plurality of physical objects that are associated with each user. The physical objects operate independently of each other and allow the system to determine a current location of each user and a possible future location of each user. As such, the system is able to interact with each user on an individual basis. To interact with each user, the system typically provides feedback to each user by generating an output signal capable of stimulating or heightening one of the user's senses. Typical output signals include an audio output, a visual output, a vibrational output or any other suitable output signal capable of heightening one of the user's senses. As such, the entertainment system is able to provide aerobic exercise by directing the movement of users through the generation of the various output signals. Moreover, the system of the present invention is suitable for use in other venues, for example, a stage floor or use as stage lighting, a dance floor, a wall or ceiling display, other health club activities such as one or more sports involving a ball and racquet, for example, tennis, squash or a sport, such as basketball or handball not requiring a racquet or other like venues.

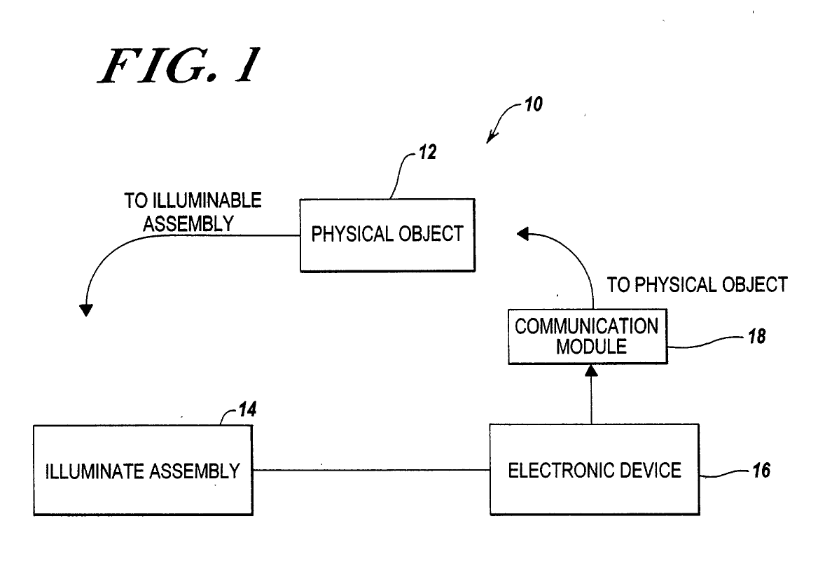

FIG. 1 is a block diagram of an exemplary interactive modular system 11 that is suitable for practicing the illustrative embodiment of the present invention. According to an illustrative embodiment, a physical object 12 communicates with a modular illuminable assembly 14 to allow the interactive modular system 10 to determine a present location of the physical object 12 relative to the modular illuminable assembly 14. The modular illuminable assembly 14 is also in communication with the electronic device 16 to provide the electronic device 16 with the data received from the physical object 12. The data received from the physical object 12 allows the electronic device 16 to identify and determine the location of the physical object 12, and to control the operation of the modular illuminable assembly 14. The electronic device 16 includes one or more processors (not shown) to process the data received from the physical object 12 and to control operation of the interactive modular system 10. Electronic devices suitable for use with the interactive modular system 10 include, but are not limited to, personal computers, workstations, personal digital assistants (PDA's) or any other electronic device capable of responding to one or more instructions in a defined manner. Those skilled in the art will recognize that the interactive modular system 10 can include more than one modular illuminable assembly 14, more than one physical object 12 and more than one electronic device 16 and more than one communication module 18, which is discussed below in more detail.

The communication link between the modular illuminable assembly 14 and the electronic device 16 is typically configured as a bus topology and may conform to applicable Ethernet standards, for example, 10 Base-2, 10 Base-T or 100 Base-T standards. Those skilled in the art will appreciate that the communication link between the modular illuminable assembly 14 and the electronic device 16 can also be configured as a star topology, a ring topology, a tree topology or a mesh topology. In addition, those skilled in the art will recognize that the communication link can also be adapted to conform to other Local Area Network (LAN) standards and protocols, such as a token bus network, a token ring network, an apple token network or any other suitable network including customized networks. Nevertheless, those skilled in the art will recognize that the communication link between the modular illuminable assembly 14 and the electronic device 16 can be a wireless link suitable for use in a wireless network, such as a Wi-Fi compatible network or a Bluetooth® compatible network or other like wireless networks.

The electronic device 16 communicates with the physical object 12 via communication module 18 in a wireless manner to enable the physical object 12 to generate an output that is capable of providing feedback to a user associated with the physical object 12. The communication module 18 communicates with the electronic device 16 using a wired communication link, for example, a co-axial cable, fiber optic cable, twisted pair wire or other suitable wired communication link. Nevertheless, the communications module 18 can communicate with the electronic device 16 in a wireless manner. The communication module 18 provides the means necessary to transmit data from the electronic device 16 to the physical object 12 in a wireless manner. Nonetheless, the physical object 12 is capable of communicating with the electronic device 16 or with the modular illuminable assembly 14 or with both in a wired manner using an energy conductor, such as one or more optical fibers, coaxial cable, triaxial cable, twisted pairs, flex-print cable, single wire or other like energy conductor.

In operation, the communication module 18 communicates with the physical object 12 using a radio frequency (RF) signal carrying one or more data packets from the electronic device 16. The RF data packets each have a unique identification value that identifies the physical object 12 that the packet is intended for. The physical object 12 listens for a data packet having its unique identification value and receives each such packet. Those skilled in the art will recognize that other wireless formats, such as code division multiple access (CDMA), time division multiplexing access (TDMA), Bluetooth technology and wireless fidelity in accordance with IEEE 802.11b are also suitable wireless formats for use with the interactive modular system 10. Moreover, those skilled in the art will recognize that the communication module 18 can be incorporated into the electronic device 16, for example as a wireless modem or as a Bluetooth capable device. Furthermore, those skilled in the art will recognize that the various wireless communications utilized by the interactive modular system 10 can be in one or more frequency ranges, such as the radio frequency range, the infrared range, and the ultra sonic range or that the wireless communications utilized by the interactive modular system 10 include magnetic fields.

Optionally, the modular illuminable assembly 14 is configurable to transmit data in a wireless manner to each of the physical objects 12. In this manner, the modular illuminable assembly 14 is able to transmit data, such as instructions, control signals or other like data to each of the physical objects 12. As such, the modular illuminable assembly 14 is able to transmit data to the physical object 12 without having to first pass the data to the electronic device 16 for transmission to the physical object 12 via the communication module 18.

Typically, each user is assigned a physical object 12. In addition, the physical object 12 is suitable for integration into one or more goods for use with the interactive modular system 10. Suitable goods include, but are not limited to footwear, balls, racquets and other similar goods for use in entertainment, amusement, exercise and sports. In this manner, the integration of the physical object 12 into selected goods allows the interactive modular system 10 to add an additional level of interaction with the user to increase the user's overall entertainment experience.

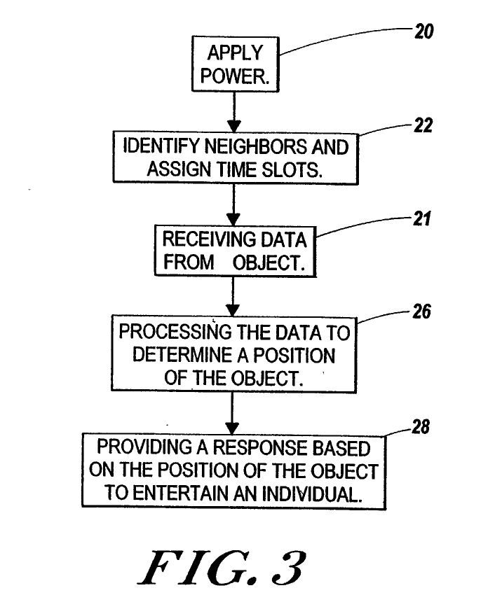

In operation, the modular illuminable assembly 14, the electronic device 16 and the physical object 12 communicate with each other using data packets and data frames. Data packets are transferred between the modular illuminable assembly 14 and the electronic device 16 that conform to the applicable Ethernet standard or other suitable protocol, such as RS-485, RS-422, or RS-232. Data frames are transferred between the physical object 12 and the modular illuminable assembly 14 using infrared communications which can be compatible with standards established by the Infrared Data Association (IrDA) or compatible with one or more other infrared communication protocols. The operation of the interactive modular system 10 is discussed below in more detail with reference to FIG. 3.

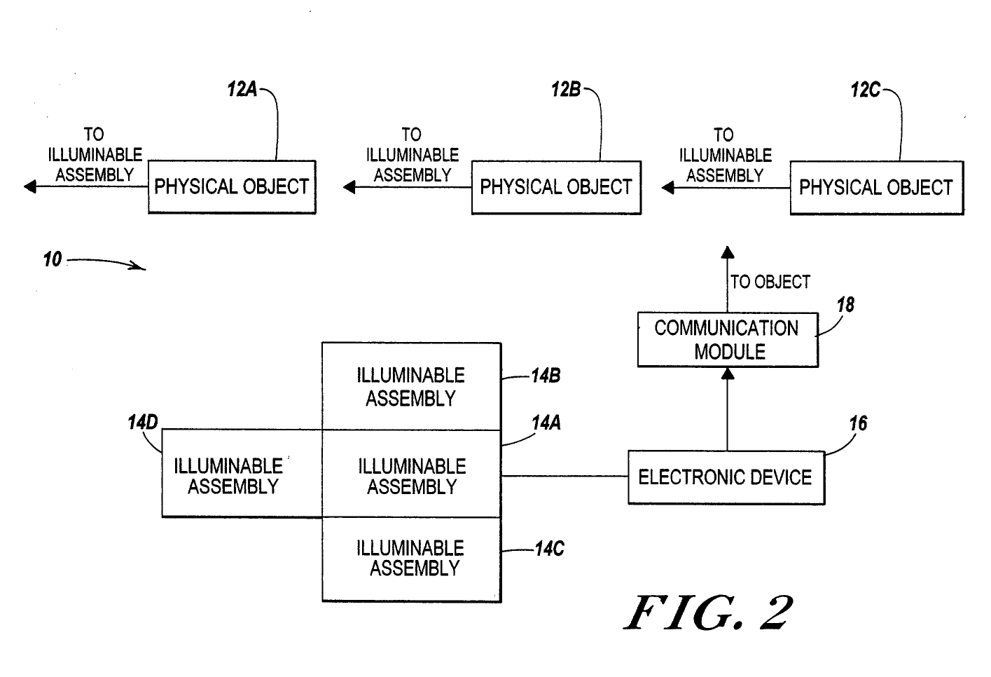

FIG. 2 illustrates an exemplary configuration of the interactive modular system 10. As FIG. 2 illustrates, the interactive modular system 10 is not just continuous configurable so that a plurality of modular illuminable assemblies 14A through 14D are coupled in a manner to form a continuous or near-continuous platform, a floor or a portion of a floor, or coupled in a manner to cover all or a portion of a ceiling, or one or more walls or both. For example, modular illuminable assembly 14A abuts modular illuminable assembly 14B, modular illuminable assembly 14C and modular illuminable assembly 14D. In addition, the interactive modular system 10 is able to entertain a plurality of users, the number of users is typically limited only by the number of modular illuminable assemblies 14 that are coupled together. Those skilled in the art will also recognize that the interactive modular system 10 can place a number of modular illuminable assemblies 14 on a wall portion of the room and a ceiling portion of the room in addition to covering the floor portion of a room with the modular illuminable assembly 14. Nevertheless, those skilled in the art will further recognize that the interactive modular system 10 can have in place on a floor portion of a room a number of the modular illuminable assemblies 14 and have in place in the room one or more other display devices that can render an image provided by the interactive modular system 10. In this manner, the other display devices can form one or more walls or portions of one or walls can render one or more images around the modular illuminable assemblies 14 on the floor portion of the room while the modular illuminable assemblies 14 of the floor portion of the room track one or more users or physical objects. Each modular illuminable assembly 14A through 14D includes a number of connectors (not shown) on each side portion or a single side portion of the modular illuminable assembly that allow for each modular illuminable assembly to communicate control signals, data signals and power signals to each abutting modular illuminable assembly 14.

In addition, each modular illuminable assembly 14 includes a unique serial number or identifier. In this manner, the unique identifier allows the electronic device 16 and optically the physical object 12, to select or identify which of the one or more modular illuminable assemblies 14A-14D it is communicating with. Those skilled in the art will recognize that the interactive modular system 10 can be configured so that a plurality of modular illuminable assemblies form various shapes or patterns on a floor, wall, ceiling or a combination thereof. Moreover, the interactive modular system 10 can be configured into one or more groups of modular illuminable assemblies, so that a first group of modular illuminable assemblies due not abut a second group of modular illuminable assemblies.

FIG. 3 illustrates steps taken to practice an illustrative embodiment of the present invention. Upon physically coupling the modular illuminable assembly 14 to the electronic device 16, and applying power to the modular illuminable assembly 14, the electronic device 16, the physical object 12 and if necessary the communications module 18, the interactive modular system 10 begins initialization. During initialization, the electronic device 16, the modular illuminable assembly 14 and the physical object 12 each perform one or more self-diagnostic routines. After a time period selected to allow the entire interactive modular system 10 to power up and perform one or more self-diagnostic routines, the electronic device 16 establishes communications with the modular illuminable assembly 14 and the physical object 12 to determine an operational status of each item and to establish each item's identification (step 20).

Once the electronic device 16 identifies each modular illuminable assembly 14 and physical object 12 in the electronic system 10, the electronic device 16 polls a selected modular illuminable assembly 14 to identify all abutting modular illuminable assemblies, for example, modular illuminable assembly 14B-14D (step 22). The electronic device 16 polls each identified modular illuminable assembly 14 in this manner to allow the electronic device 16 to generate a map that identifies a location for each modular illuminable assembly 14 in the interactive modular system 10. In addition to mapping each modular illuminable assembly 14 as part of the initialization of the interactive modular system 10, the electronic device 16 receives from each physical object 12 the object's unique identification value and in turn, assigns each physical object 12 a time slot for communicating with each modular illuminable assembly 14 in the interactive modular system 10 (step 22). Upon mapping of each modular illuminable assembly 14 and assignment of time slots to each physical object 12, the interactive modular system 10 is capable of entertaining or amusing one or more users.

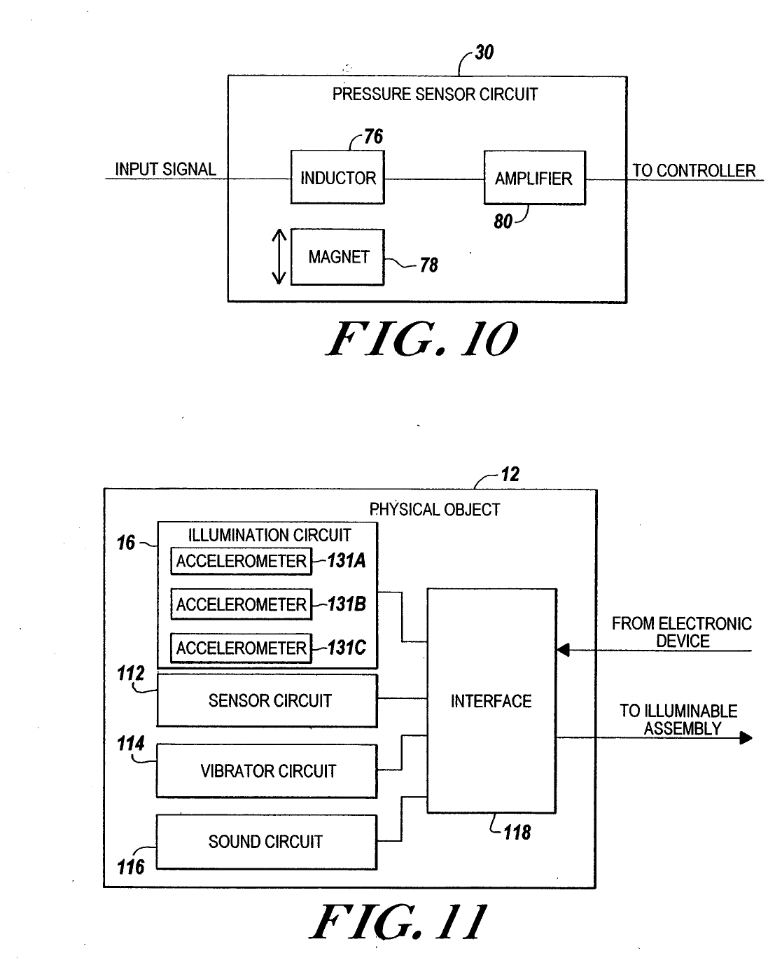

In operation, the modular illuminable assembly 14 receives a data frame from the physical object 12. The data frame contains indicia to identify the physical object 12 and data regarding an acceleration value of the physical object 12 (step 24). A suitable size of a data frame from the physical object 11 is about 56 bits, a suitable frame rate for the physical object 12 is about twenty frames per second. In one embodiment, each user is assigned two physical objects 12. The user attaches a first physical object 12 to the tongue or lace portion of a first article of footwear and attaches a second physical object 12 to the tongue or lace portion of a second article of footwear. The physical object 12 is discussed below in more detail with reference to FIG. 10.

When the modular illuminable assembly 14 receives a data frame from the physical object 12, the modular illuminable assembly 14 processes the data frame to identify the source of the data frame and if instructed to, validate the data in the frame by confirming a Cyclic Redundancy Check (CRC) value or checksum value or other method of error detection provided in the frame (step 24). Once the modular illuminable assembly 14 processes the data frame from the physical object 12, the modular illuminable assembly 14 generates an Ethernet compatible data packet that contains the data from the physical object 12 and transfers the newly formed Ethernet packet to the electronic device 16 which, in turn, determines a present location of the physical object 12 in the interactive modular system 10. The electronic device 16 determines the present location of the physical object 12 based on the data transmitted by the physical object 12 along with the source address of the modular illuminable assembly 14 that transfers the data from the physical object 12 interactive modular system 10. In this manner, if the physical object 12 is attached to or held by a particular user, that user's location in the interactive modular system 10 is known. Those skilled in the art will recognize that the modular illuminable assembly 14 is capable of transmitting data using an IR signal to the physical object 12.

The electronic device 16 processes the acceleration data or the position data provided by the physical object 12 to determine a position of the physical object 12 and optionally a speed of the physical object 12 or a distance of the physical object 12 relative to the physical object's last reported location or a fixed location in the interactive modular system 10, or both a speed and distance of the physical object 12 (step 26). The electronic device 16 directs the modular illuminable assembly 14 to generate an output based on a position of the physical object 12 and optionally an output based on the velocity of the physical object 12 and optionally the distance traveled by the physical object 12. The output is capable of stimulating one of the user's senses to entertain and interact with the user (step 28). In addition, the electronic device 16 can direct the physical object 12 to generate on output capable of stimulating one of the user's senses to entertain and interact with the user.

The modular illuminable assembly 14 is capable of generating a visual output in one or more colors to stimulate the users visual senses. Depending on the entertainment mode of the interactive modular system 10, the visual output generated by the modular illuminable assembly 14 can provide feedback to the user in terms of instructions or clues. For example, the modular illuminable assembly 14 can illuminate in a green color to indicate to the user that they should move in that direction or to step onto the modular illuminable assembly 14 illuminated green or to hit or throw the physical object 12 so that it contacts the modular illuminable assembly 14 illuminated green. In similar fashion, the modular illuminable assembly 14 can be instructed to illuminate in a red color to instruct the user not to move in a particular direction or not to step onto the modular illuminable assembly 14 illuminated red. Nevertheless, those skilled in the art will recognize that the modular illuminable assembly 14 is controllable to illuminate or display a broad spectrum of colors.

The physical object 12 can also provide the user with feedback or instructions to interact with the interactive modular system 11. For example, a selected physical object 12 associated with a selected user can generate a visual output in a particular color to illuminate the selected physical object 12. In this manner the interactive modular system 10 provides an additional degree of interaction with the user. For example, the visual output of the physical object 10 can indicate that the selected user is no longer an active participant in a game or event, or that the selected user should be avoided, such as the person labeled “it” in a game of tag.

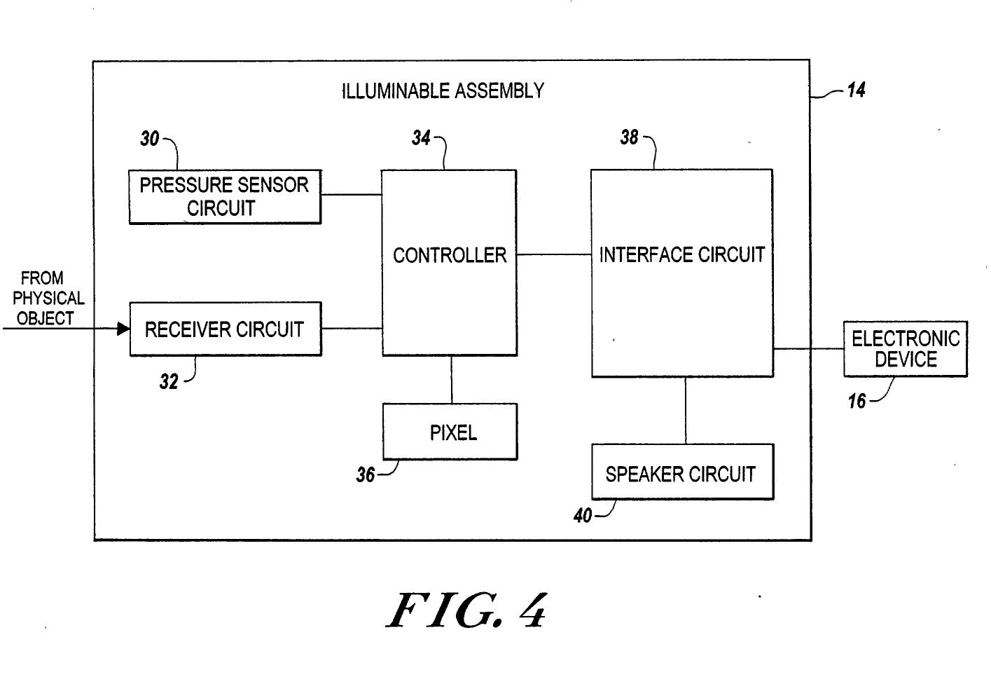

FIG. 4 schematically illustrates the modular illuminable assembly 14 in more detail. A suitable mechanical layout for the modular illuminable assembly 14 is described below in more detail relative to FIG. 15. The modular illuminable assembly 14 is adapted to include an interface circuit 38 coupled to the controller 34, the speaker circuit 40 and the electronic device 16. The interface circuit 38 performs Ethernet packet transmission and reception with the electronic device 16 and provides the speaker circuit 40 with electrical signals suitable for being converted into sound. The interface circuit 38 also transfers and parses received data packets from the electronic device 16 to the controller 34 for further processing.

The modular illuminable assembly 14 also includes a pressure sensor circuit 30, a receiver circuit 32 and a pixel 36 coupled to the controller 34. The controller 34 provides further processing of the data packet sent by the electronic device 16 to determine which pixel 36 the electronic device 16 selected along with a color value for the selected pixel 36. The pressure sensor circuit 30 provides the controller 34 with an output signal having a variable frequency value to indicate the presence of a user on a portion of the modular illuminable assembly 14. The receiver circuit 32 interfaces with the physical object 12 to receive data frames transmitted by the physical object 12. The receiver circuit 32 processes and validates each data frame received from the physical object 12, as discussed above, and forwards the validated data frame from the physical object 12 to the controller 34 for transfer to the interface circuit 38.

In operation, the receiver circuit 32 receives data frames from each physical object 12 within a particular distance of the modular illuminable assembly 14. The receiver circuit 32 processes the received data frame, as discussed above, and forwards the received data to the controller 34. The controller 34 forwards the data from the receiver circuit 32 to the interface circuit 38 to allow the interface circuit 38 to form an Ethernet packet. Once the Ethernet packet is formed, the interface circuit 38 transfers the packet to the electronic device 16 for processing. The electronic device 16 processes the data packets received from the interface circuit 38 to identify the physical object 12 and determine a velocity value of the identified physical object 12.

The electronic device 16 uses the source identification from the modular illuminable assembly 14 along with identification value received from the physical object 12 and optionally a velocity value from the physical object 12 to determine a current location of the physical object 12. Optionally, the electronic device 16 also determines a possible future location of the physical object 12. The electronic device 16 can also determine from the data provided a distance between each physical object 12 active in the interactive modular system 10.

The electronic device 16, upon processing the data from the physical object 12, transmits data to the modular illuminable assembly 14 that instructs the modular illuminable assembly 14 to generate a suitable output, such as a visual output or an audible output or both. Optionally, the electronic device 16 also transmits data to the identified physical object 12 to instruct the physical object 12 to generate a suitable output, for example, a visual output, a vibrational output or both.

The interface circuit 38 upon receipt of an Ethernet packet from the electronic device 16 stores it on chip memory and determines whether the frames destination address matches the criteria in an address filter of the interface circuit 38. If the destination address matches the criteria in the address filter, the packet is stored in internal memory within the interface circuit 38. The interface circuit 38 is also capable of providing error detection such as CRC verification or checksum verification, to and verify the content of the data packet. The interface circuit 38 parses the data to identify the controller 34 responsible for controlling the selected pixel and transfers the appropriate pixel data from Ethernet packet to the identified controller 34. In addition, the interface circuit 38 is responsible for enabling the speaker circuit 40 based on the data received from the electronic device 16.

The modular illuminable assembly 14 allows the interactive modular system 10 to advantageously detect and locate the physical object 12 even if the physical object 12 is not in direct contact with the modular illuminable assembly 14. As such, when a user attaches a physical object 12 to a portion of their footwear, the interactive modular system 10 can detect the presence of the user's foot above one or more of the modular illuminable assemblies 14 and determine whether the user's foot is stationary or in motion. If a motion value is detected, the interactive modular system 10 can advantageously determine a direction in which the user's foot is traveling relative to the modular illuminable assembly 14. As a result, the interactive modular system 10 can predict which modular illuminable assembly 14 the user is likely to step onto next and provide instructions to each possible modular illuminable assembly 14 to generate an output response, whether it be a visual or audible to interact and entertain the user. Consequently, the interactive modular system 10 can block the user from moving in a particular direction before the user takes another step. As such, the electronic system 10 is able to track and interact with each user even if each pressure sensor circuit 30 becomes inactive or disabled in some manner.

FIG. 5 illustrates an exemplary modular illuminable assembly 14 having more than one pixel 36 and more than one controller 34. The modular illuminable assembly 14 illustrated in FIG. 4 operates in the same manner and same fashion as described above with reference to FIG. 2 and FIG. 3. FIG. 5 illustrates that the modular illuminable assembly 14 is adaptable in terms of pixel configuration to ensure suitable visual effects in a number of physical locations. For example, the modular illuminable assembly 14 illustrated in FIG. 5 is divided into four quadrants. The first quadrant including the controller 34A coupled to the receiver 32A, the pressure sensor circuit 30A, pixels 36A-36D and the interface circuit 38. In this manner, the interface circuit 38 is able to parse data received from the electronic device 16 and direct the appropriate data to the appropriate controller 34A-34D to control their associated pixels. The configuring of the modular illuminable assembly 14 into quadrants also provides the benefit of being able to disable or enable a selected quadrant if one of the controllers 34A-36D or if one or more of the individual pixels 36A-36Q fail to operate properly.

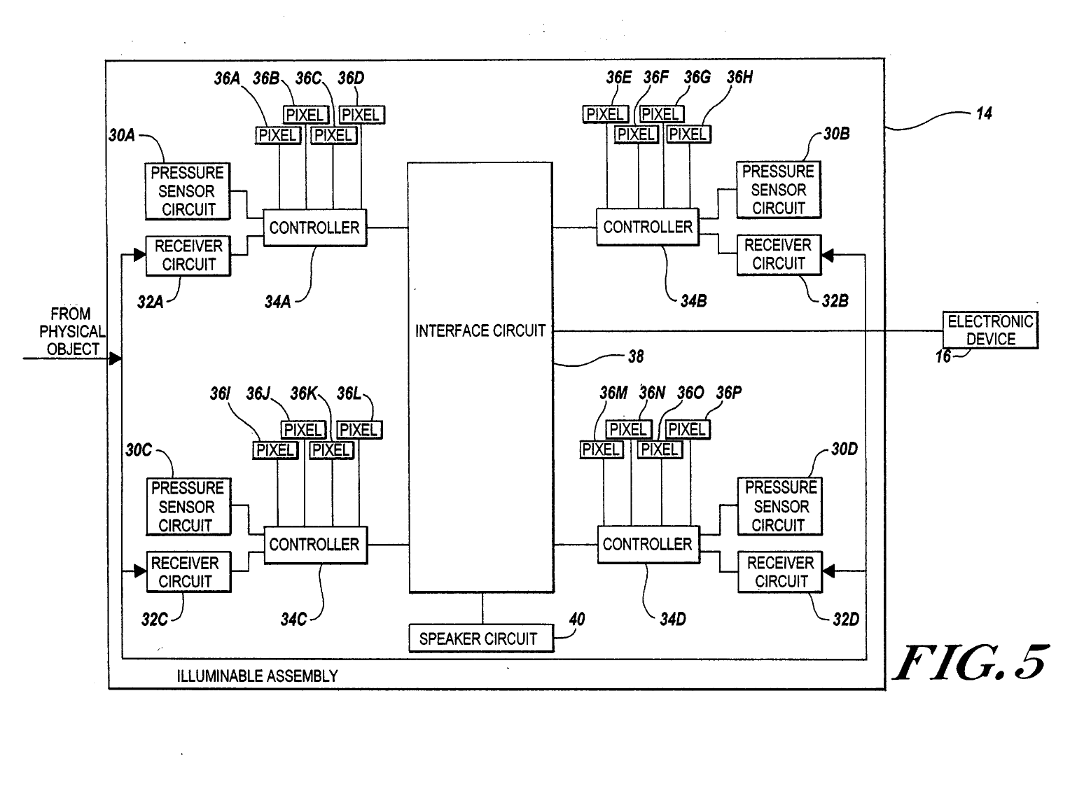

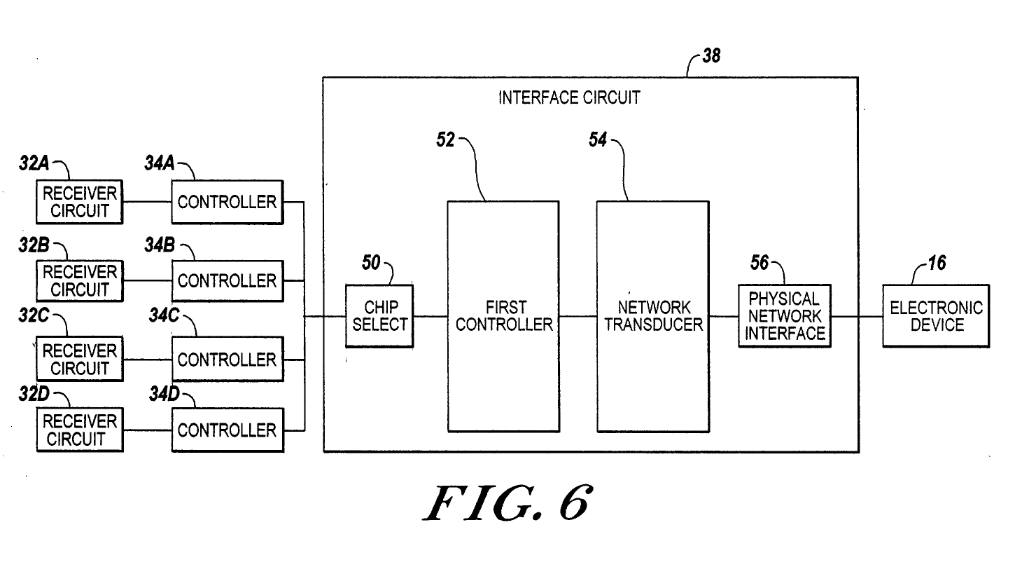

FIG. 6 depicts the interface circuit 38 in more detail. The interface circuit 38 is adapted to include a physical network interface 56 to allow the interface circuit 38 to communicate over an Ethernet link with the electronic device 16. The interface circuit 38 also includes a network transceiver 54 in communication with the physical network interface 56 to provide packet transmission and reception. A first controller 52 in communication with the network transceiver 54 and chip select 50 (described below) is also included in the interface circuit 38 to parse and transfer data from the electronic device 16 to the controller 34.

The physical network interface 56 provides the power and isolation requirements that allow the interface circuit 38 to communicate with the electronic device 16 over an Ethernet compatible local area network. A transceiver suitable for use in the interface circuit 38 is available from Halo Electronics, Inc. of Mountain View, Calif. under the part number MDQ-001.

The network transceiver 54 performs the functions of Ethernet packet transmission and reception via the physical network interface 56. The first controller 52 performs the operation of parsing each data packet received from the electronic device 16 and determining which controller 34A through 34D should receive that data. The first controller 52 utilizes the chip select 50 to select an appropriate controller 34A through 34D to receive the data from the electronic device 16. The chip select 50 controls the enabling and disabling of a chip select signal to each controller 34A through 34D in the modular illuminable assembly 14. Each controller 34A through 34D is also coupled to a corresponding receiver circuit 32A through 34D. Receiver circuit 34A through 34D operate to receive data from the physical object 12 and forward the received data to the respective controller 34A through 34D for forwarding to the electronic device 16. The receiver 34A through 34D is discussed below in more detail relative to FIG. 8. In this manner, the first controller 52 is able to process data from the electronic device 16 in a more efficient manner to increase the speed in which data is transferred within the modular illuminable assembly 14 and between the modular illuminable assembly 14 and the electronic device 16. In addition, the use of the chip select 50 provides the modular illuminable assembly 14 with the benefit of disabling one or more controllers 34A through 34D should a controller or a number of pixels 36A through 36Q fail to operate properly. Those skilled in the art will recognize that the interface circuit 38 can be configured to operate without the chip select 50 and the first controller 52.

A controller suitable for use as the first controller 52 and the controller 34 is available from Microchip Technology Inc., of Chandler, Ariz. under the part number PIC16C877. A controller suitable for use as the network transceiver 54 is available from Cirrus Logic, Inc. of Austin, Tex. under the part number CS8900A-CQ. A chip select device suitable for use as the chip select 50 is available from Phillips Semiconductors, Inc. of New York under the part number 74AHC138.

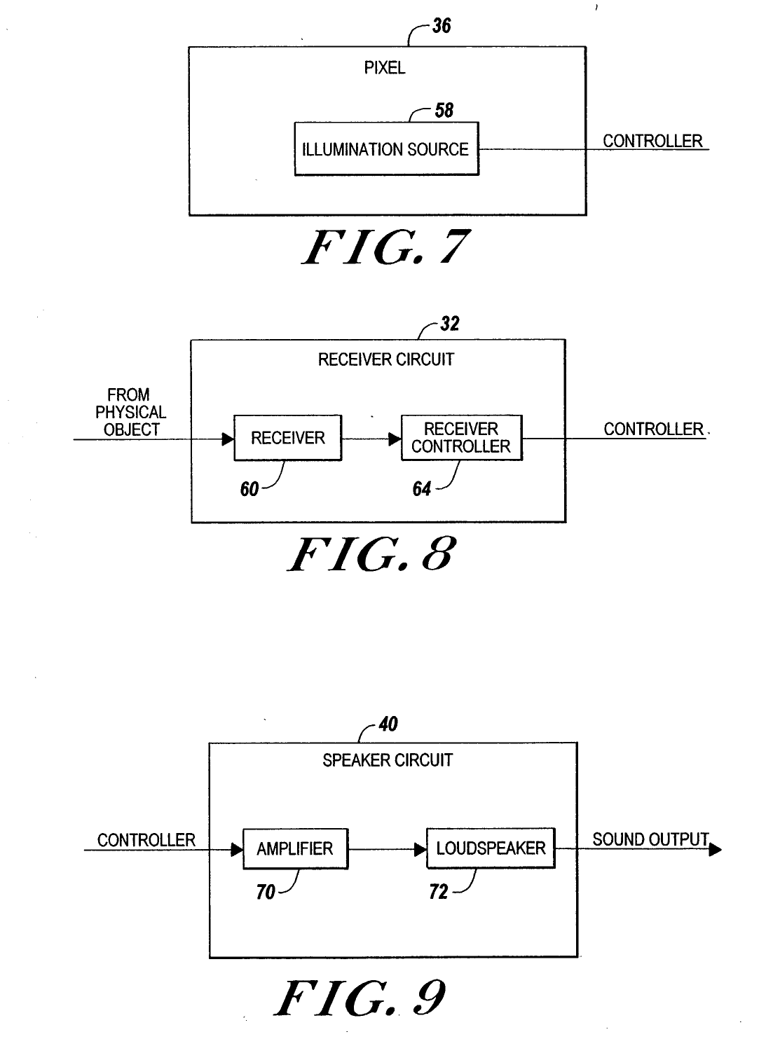

FIG. 7 illustrates the pixel 36 in more detail. The pixel 36 includes an illumination source 58 to illuminate the pixel 36. The illumination source 58 is typically configured as three light emitting diodes (LEDs), such as a red LED, a green LED and a blue LED. The illumination source 58 can also be configured as an Electro Illuminasence (EL) back lighting driver, as one or more incandescent bulbs, or as one or more neon bulbs to illuminate the pixel 36 with a desired color and intensity to generate a visual output. The electronic device 16 provides the modular illuminable assembly 14 with data that indicates a color and an illumination intensity for the illumination source 58 to emit. Those skilled in the art will recognize that other illumination technologies, such as fiber optics or gas charged light sources or incandescent sources are suitable for use as the illumination source 58.

The data that indicates the color and the illumination intensity of the illumination source 58 to emit are converted by the illumination assembly 14 from the digital domain to the analog domain by one or more digital to analog converters (DACs) (not shown). The DAC is an 8-bit DAC although one skilled in the art will recognize that DAC's with higher or lower resolution can also be used. The analog output signal of the DAC is feed to an operational amplifier configured to operate as a voltage to current converter. The current value generated by the operational amplifier is proportional to the voltage value of the analog signal from the DAC. The current value generated by the operational amplifier is used to drive the illumination source 58. In this manner, the color and the illumination intensity of the illumination source 58 is controlled with a continuous current value. As such, the interactive modular system 10 is able to avoid or mitigate noise issues commonly associated with pulse width modulating an illumination source. Moreover, by supplying the illumination source 58 with a continuous current value, that current value for the illumination source 58 is essentially latched, which, in turn, requires less processor resources than an illumination source receiving a pulse width modulated current signal.

FIG. 8 illustrates the receiver circuit 32 in more detail. The receiver circuit 32 is configured to include a receiver 60 to receive data from the physical object 12 and a receiver controller 64 to validate and transfer the received data to the controller 34. In more detail, the receiver 60 is an infrared receiver that supports the receipt of an infrared signal carrying one or more data frames. The receiver 60 converts current pulses transmitted by the physical object 12 to a digital TTL output while rejecting signals from sources that can interfere with operation of the modular illuminable assembly 14. Such sources include sunlight, incandescent and fluorescent lamps. A receiver suitable for use in the receiver circuit 32 is available from Linear Technology Corporation of Milpatis, Calif. under the part number LT1328.

The receiver controller 64 receives the output of the receiver 60, identifies the physical object 12 that transmitted the data frame and optionally validates the frame by confirming a CRC value or a checksum value, or other error detection value sent with the frame. Once the receiver controller 64 verifies the data frame, it forwards the data frame to the controller 34 for transfer to the electronic device 16. A receiver controller suitable for use in the receiver circuit 32 is available from is available from Microchip Technology Inc., of Chandler, Ariz. under the part number PIC 16C54C.

FIG. 9 illustrates the speaker circuit 40 for generating an audible output to heighten a user's senses. The speaker circuit 40 is adapted to include an amplifier 70 and a loudspeaker 72. The amplifier 70 is an audio amplifier that amplifies an audio input signal from the interface circuit 38 to drive the loudspeaker 72. The loudspeaker 72 converts the electrical signal provided by the amplifier 70 into sounds to generate an audible output. Those skilled in the art will recognize that the audible output can be generated in other suitable manners, for example, wireless headphones worn by each user. Moreover, those skilled in the art will recognize that the modular illuminable assembly 14 forms a housing for the loudspeaker 72.

FIG. 10 illustrates the pressure sensor circuit 30 in more detail. The pressure sensor circuit 30 includes an inductor 76, a magnet 78 and an amplifier 80. The inductor 76 is located in a magnetic field of the magnet 78 and coupled to the amplifier 80. The inductor 76 and the amplifier 80 form an oscillator circuit that oscillates at a base frequency of about 200 kHz. The magnet 78 moves upward and downward in a plane perpendicular to the inductor 76 so that the magnetic forces exerted by the magnet 78 on the inductor 76 varies with the movement of the magnet 78. The upward and downward movement of the magnet 78 is based on the amount of pressure a user exerts on a portion of the modular illuminable assembly 14. As such, the magnetic force exerted by the magnet 78 on the indicator 76 varies with the movement of the magnet 78 to cause the frequency of the oscillator circuit to vary. The oscillator circuit formed by the indicator 76 and the amplifier 80 provide the controller 34 with an output signal that indicates a pressure value exerted on at least a portion of the modular illuminable assembly 14 by one or more users.

FIG. 11 illustrates the physical object 12 in more detail. The physical object 12 includes an interface circuit 118 to communicate with the electronic device 16 and the modular illuminable assembly 14. The physical object 12 also includes all illumination circuit 10 in communication with the interface circuit 118, a sensor circuit 112, a vibrator circuit 114 and a sound circuit 116. The illumination circuit 110 provides a visual output, to illuminate the physical object 12. The sensor circuit 112 measures a physical stimulus of the physical object 12, such as motion of the physical object 12 in an X-axis, Y-axis and Z-axis and provides the interface circuit 118 with a response that indicates an acceleration value of the physical object 12 in at least one of the three axis's. The vibrator circuit 114 is capable of generating a vibrational output when enabled by the interface circuit 118 to provide an output capable of heightening one of the user's senses. The sound circuit 116 is also under the control of the interface circuit 118 and is able to generate an audible output.

The illumination circuit 110 typically includes three LED's (not shown) such as a red, blue and green LED to illuminate the physical object 12 when enabled by the interface circuit 118. Those skilled in the art will recognize that the illumination circuit 110 can include more than three LED′ or less than three LED's. Moreover, those skilled in the art will appreciate that the illumination circuit 100 can include an Electro Illuminasence (EL) back lighting driver, one or more incandescent bulbs, or one or more neon bulbs to generate the visual output or other illumination technologies.

The sensor circuit 112 typically includes three accelerometers (accelerometers 131A-131C) or in the alternative, three inclinometers to measure a physical stimulus on the physical object 12. The sensor circuit 112 is capable of sensing the physical stimulus in one or more of three axis's, for example, an X-axis, a Y-axis and a Z-axis, and provide a response to the interface circuit 118 that indicates an acceleration value of the physical object 12 in at least one of the three axes. In the alternative, if the sensor circuit 112 is adapted with one or more inclinometers (not shown) then the sensor circuit 112 provides a response to the interface circuit 118 that indicates the inclination of the physical object 12 relative to the horizontal of at least one of three axes. Those skilled in the art will recognize that the physical object 12 can be adapted to include other sensor elements or sensor like elements, such as a gyroscope capable of providing angular information or a global positioning system.

The vibrator circuit 114 includes a mechanism (not shown), such as motor that generates vibrational force when enabled by the interface circuit 118. The vibrational force generated by the vibrator circuit 114 having a sufficient force, duration and frequency to allow a user to sense the vibration when the physical object 12 is coupled to the user's foot ware.

The sound circuit 116 includes a loudspeaker (not shown), and optionally includes an amplifier to amplify an electrical signal provided by the interface circuit 118 and drive the loudspeaker with an amplified signal. The loudspeaker allows the physical object 12 to generate a sound output when directed to do so by the electronic device 16.

The physical object 12 is provided with a unique serial number that is used by the interactive modular system 10 to identify the physical object 12. The unique serial number of the physical object 12 can be associated with a particular user through a user profile, a user account, a user name, or other like data record so as to select a game or activity the user wishes to participate in, or to track an amount of system use by the user.

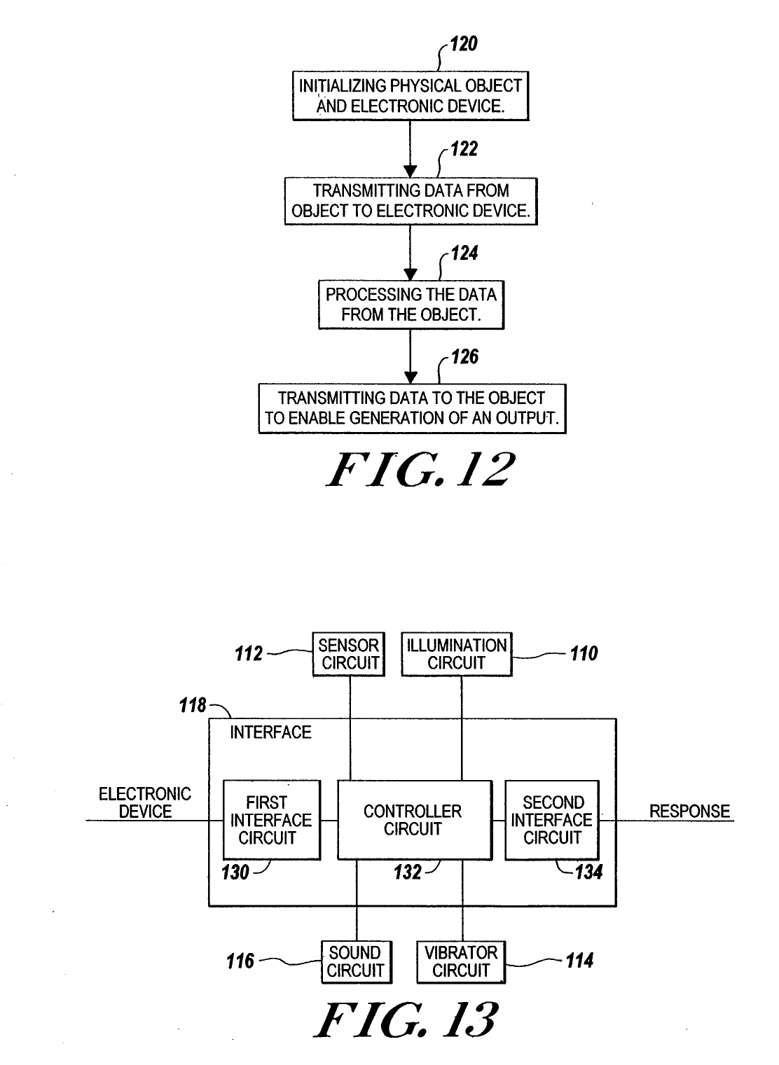

FIG. 12 illustrates the steps taken to operate the physical object 112 in the interactive modular system 10. The physical object 12 at power up performs a self-diagnostic routine. Upon completion of the self-diagnostic routine, the physical object 12 awaits a frame synchronization pulse from the electronic device 16 (step 120). Once the physical object 12 is synchronized with the electronic device 16, the physical object 12 transmits a data frame to provide the electronic device 16 with indicia that identifies that particular physical object 12 (step 120). Once the electronic device 16 receives the identification from the physical object the electronic device 16 can assign the physical object 12 a new identification if a conflict is detected amongst other physical objects, otherwise, the electronic device 16 utilizes the provided identification to communicate with the physical object 12. Each data packet transmitted by the electronic device 16 includes a unique identifier that identifies the intended physical object 12. The unique identifier is typically the physical object's unique identification unless it runs reassigned. (Step 120).

In operation, the physical object 12 communicates with the electronic device 16 via the modular illuminable assembly 14 in its assigned time slot to provide the electronic device 16 with the response from the sensor circuit 112 (step 122). The electronic device 16 processes the response data provided by the physical object 12 to determine at least a current location of the physical object 12 relative to a selected modular illuminable assembly 14 (step 124). If desired, the electronic device 16 can determine a location of a selected physical object 12 relative to one or more other physical objects 12. Those skilled in the art will recognize that the modular illuminable assembly can be configured to transmit data to the physical object 12 in a wired or wireless manner. Moreover, those skilled in the art will recognize the physical object 12 can be configured to communicate with other physical objects in a wired or wireless manner. Nevertheless, those skilled in the art will recognize that the physical object 12 and the modular illuminable assembly 14 communicate in a manner that does not interfere with communications between other physical objects and modular illuminable assemblies.

Once the electronic device 16 determines a location of the physical object 12, the electronic device 16 is able to instruct the physical object 12 to generate an output based on an analysis of various system variables (step 126). Possible variables include, but are not limited to, number of users, location of the physical object 12, velocity of the physical object 12, and type of entertainment being provided, such as an aerobic exercise.

FIG. 13 illustrates the interface circuit 118 in more detail. The interface circuit 118 includes a first interface circuit 130 in communication with controller circuit 132, which, in turn, is in communication with a second interface circuit 134. The controller circuit 132 is also in communication with the illumination circuit 110, the sensor circuit 112, the vibrator circuit 114 and the sound circuit 116. The first interface circuit 130 also communicates with the electronic device 16 while the second interface circuit 134 also communicates with the illumination circuit 110, the sensory circuit 112, the vibrator circuit 114 and the sound circuit 116.

The first interface circuit 130 operates to receive and condition the data transmitted by the communication module 18 from the electronic device 16. Once the first interface circuit 130 receives and conditions the data from the electronic device 16, the first interface circuit 130 transfers the data to the controller circuit 132 for further processing. The controller circuit 132 process the received data to coordinate operation of the illumination circuit 110, the sensor circuit 112, the vibrator circuit 14 and the sound circuit 116 within the physical object 12. The controller circuit 132 also processes the response from the sensor circuit 112 by digitizing the data and to coordinate transmission of the sensor response during the assigned data frame. The second interface circuit 134 transmits a data packet to the modular illuminable assembly 14 to provide the electronic device 16 with the response from the sensor circuit 112. A controller suitable for use as the controller circuit 132 is available from Microchip Technology Inc., of Chandler, Ariz. under the part number PIC16C877.

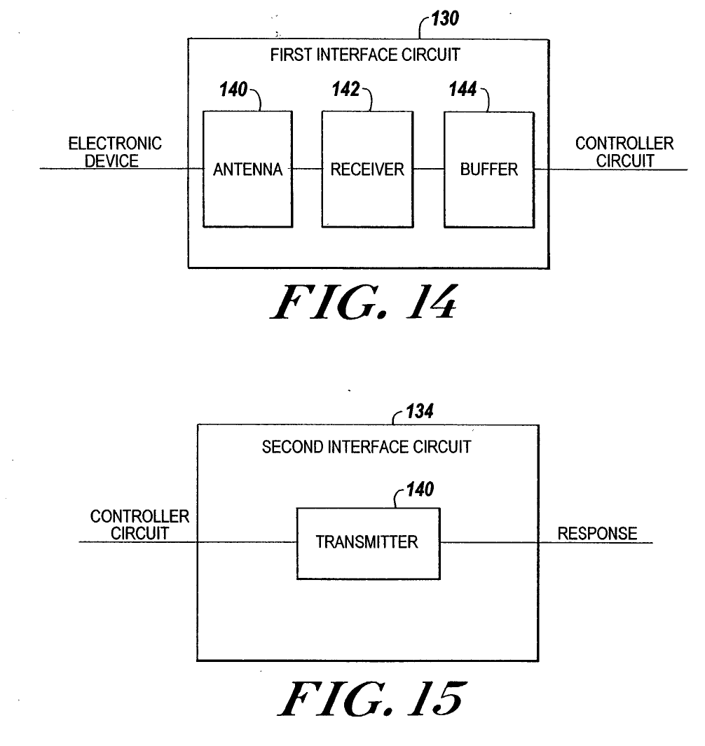

FIG. 14 illustrates the first interface circuit 130 in more detail. The first interface circuit 130 includes an antenna 140 in communication with a receiver 142. The receiver 142 is also in communication with a buffer 144. The antenna 140 receives the data transmitted by the electronic device 16 via the communication module 118 and forwards that data to the receiver 142. The receiver 142 processes and conditions the received data by converting it from an analog state to a digital state before the data is transferred to the buffer 144. The buffer 144 buffers the data from the receiver 142 to minimize the influence of the receiver circuit 142 on the controller circuit 132. A receiver suitable for use in the first interface circuit 142 is available from RF Monolithics, Inc. of Dallas, Tex. under the model number DR5000.

FIG. 15 illustrates the second interface circuit 134 in more detail. The second interface circuit 134 includes a transmitter 140 to transmit the response from the sensor circuit 112 to the modular illuminable assembly 14. The transmitter circuit 140 includes one or more infrared LED's to transmit the response using an infrared output signal suitable for receipt by the receiver circuit 32 within the illuminable assembly 114.

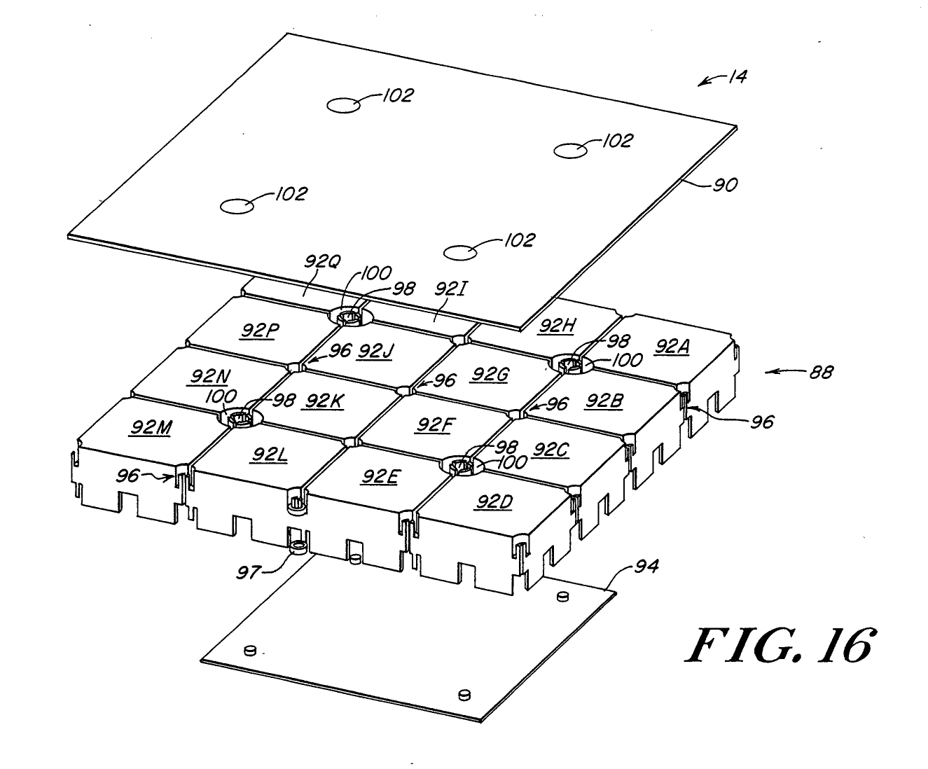

FIG. 16 illustrates a mechanical layout of the modular illuminable assembly 14. The modular illuminable assembly 14 includes a top portion 90, a modular mid-portion 88 and a base portion 94. The top portion 90 includes a filter portion 102 that operates in conjunction with the receiver circuit 32 to attenuate frequencies outside of the receiver's frequency range. The top portion 90 is manufactured from a material having translucent properties to allow light to pass through. Top portion 90 operates as a protective layer to the modular mid-portion 88 to prevent damage to the modular mid-portion 88 when a user steps onto the modular illuminable assembly 14. The top portion 90 can be configured as an assembly having a continuous side profile or as an assembly having a layered side profile that represents a plurality of disposable layers that can be removed as a top layer becomes damaged or dirty. The top portion 90 also serves as a mechanical base to hold one or more magnets for use in conjunction with one or more of the pressure sensor circuits 10 discussed above in more detail.

The modular mid-portion 88 includes pixel housings 92A through 92Q that house pixels 36A through 36Q. Pixel housings 92A through 92Q are of uniform shape and size and are interchangeable with one another. Each pixel housing 92A through 92Q may be molded out of a polycarbonate material of suitable strength for supporting the weight of a human being. The pixel housings are grouped as a set of four housings, for example, 92A, 92B, 92G and 92H. When four pixel housings, such as 92A, 92B, 92G and 92H are coupled they form a first radial housing 98 and a second radial housing 100 at a location where all four pixel housings contact each other. The first radial housing 98 houses a portion of the receiver 60, discussed in detail above. The second radial housing 100 houses the magnet 78 discussed in detail above. Each pixel housing 92A through 92Q also include a portion adapted to include a fastener portion 96 to receive a fastening mechanism, such as fastener 97 to secure each pixel housing 92A through 92Q to each other and to the base portion 94.

The base portion 94 has the pressure sensor circuit 30, the receiver circuit 32, the control circuit 34, the interface circuit 38 and the speaker circuit 40 mounted thereto. Also mounted to the bottom portion 94 are the various interconnections that interconnect each of the components illustrated in the modular illuminable assembly 14 of FIGS. 4 and 5.

Typically, the modular illuminable assembly 14 is configured as a square module having a length measurement of about sixteen inches and a width measurement of about sixteen inches. The modular mid-portion 88 is typically configured with sixteen pixel housings 92A through 92Q to house sixteen pixels 36A through 36Q, four receivers 32 and four magnets 78. Nevertheless, those skilled in the art will recognize that the modular illuminable assembly 14 can be configured to have a smaller overall mechanical footprint that would include a smaller number of pixel housings, such as four pixel housings or less, or in the alternative, configured to have a larger overall mechanical footprint to include more than sixteen pixel housings, such as twenty-four pixel housings or thirty-two pixel housings or more. Moreover, the modular illuminable assembly 14 facilitates transportability of the interactive modular system 10, to allow the interactive modular system 10 to be transported from a first entertainment venue to a second entertainment venue without the need for specialized tradesmen.

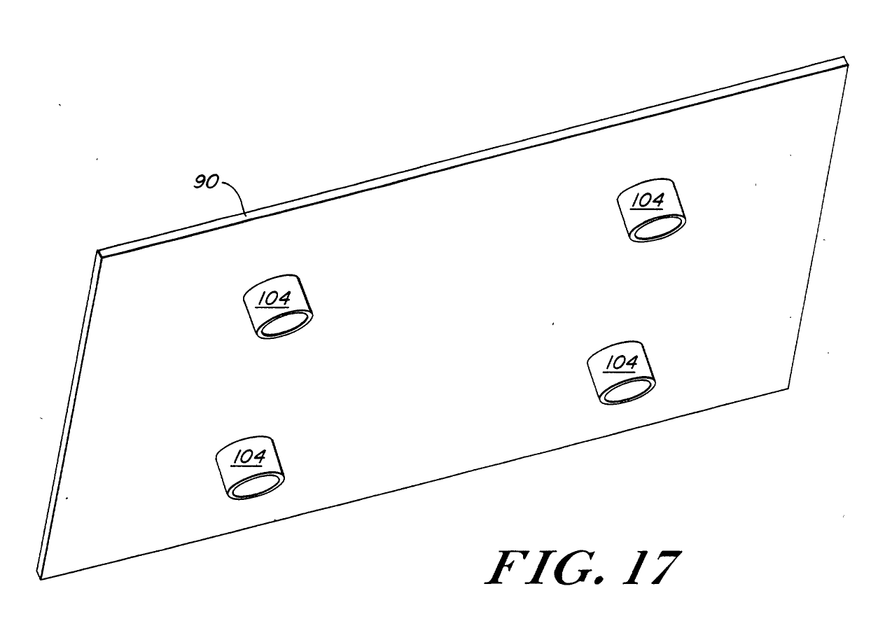

FIG. 17 illustrates a bottom side of the top portion 90. As illustrated, the top portion 90 is configured with one or more support columns 104. The support columns 104 are sized to fit within the second radial housing 100. The support columns 104 provide support for the top portion 90 when placed in communication with the modular mid-portion 88. Each support column 104 includes a diameter and a wall thickness compatible with a diameter and opening distance of the second radial housing 100 located in the modular mid-portion 88. Typically, each support column 104 moves upward and downward in a vertical direction within the second radial housing 100 and rests upon a flexible surface inserted into the second radial housing 100. Each support column 104 is also coupled with the magnet 78 (not shown) so that the magnet 78 moves in an upward and downward direction with the support column 104. The coupling of the magnet 78 to each support column 104 allows each pressure sensor circuit 30 to detect a magnitude of pressure exerted by a user on a portion of the modular illuminable assembly 14.

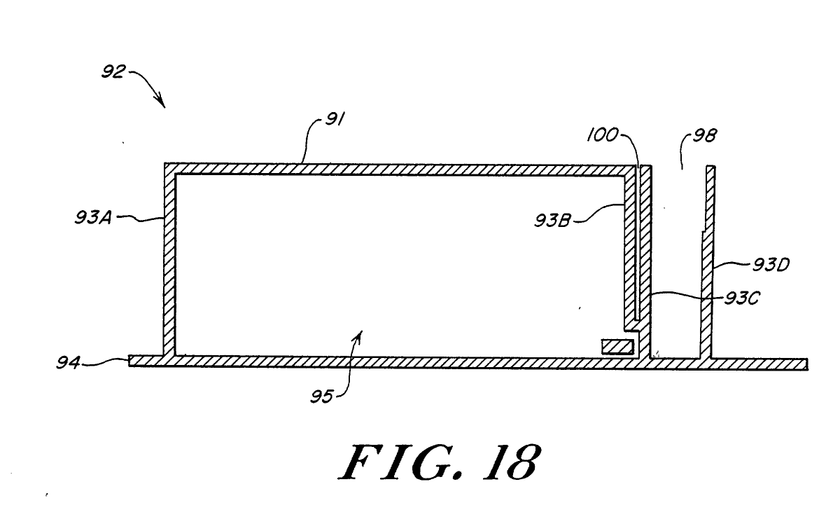

FIG. 18 illustrates a side view of a pixel housing 92. As illustrated, each pixel housing 92 includes a first side portion 93A in contact with the bottom portion 94 of the modular illuminable assembly 14, a second side portion 93B and a third side portion 93C that form a portion of the second radial housing 100. The third side portion 93C and a fourth side portion 93D also contact the bottom portion 94 of the modular illuminable assembly 14 to provide additional support for the pixel housing 92. The third side portion 93C and fourth side portion 93D form a portion of the first radial housing 98. Each pixel housing 92 also includes a top portion 91. FIG. 18 also illustrates a suitable location of the inductor 76 discussed above with reference to FIG. 10. Each pixel housing 92 includes an open bottom portion 95 to fit over the illumination source 58 discussed above with reference to FIG. 7.

The pixel housing 92 provides a low cost durable housing that can be used in any location through out the modular mid-portion 88. As a result, a damaged pixel housing 92 within the modular mid-portion 88 can be replaced in a convenient manner. As a result, the modular illuminable assembly 14 provides a repairable assembly that minimizes the need to replace an entire modular illuminable assembly 14 should a pixel housing 92 become damaged.

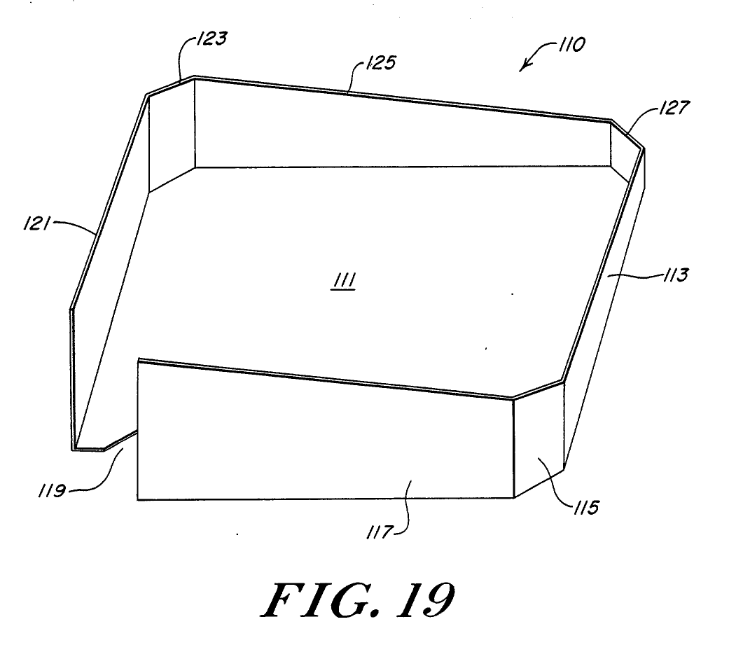

FIG. 19 illustrates a diffuser element 110 suitable for use with each of the pixel housings 92A through 92Q to diffuse light emitted by the illumination source 58. The diffuser element 110 helps assure that light emitted from the illumination source 58 exhibits a uniform color and color intensity across the entire top portion 91 of the pixel housing 92. The diffuser element 110 fits within the pixel housing 92 and includes an opening 119 to receive the illumination source 58. The diffuser element 110 includes a bottom portion 111 that reflects light emitted from the illumination source 58 upward towards the top portion 91 of the pixel housing 92 for projection through the top portion 90 of the modular illuminable assembly 14.

The diffuser element 110 also includes a first tapered side portion 117 connected to a first mitered corner portion 115, which is connected to a second tapered side portion 113. The second tapered side portion 113 is also connected to a second mitered corner portion 127, which is connected to a third tapered side portion 125. The third tapered side portion 125 is also connected to third mitered corner portion 123, which is connected to a fourth tapered side portion 121. The diffuser element 110 includes an open top portion.

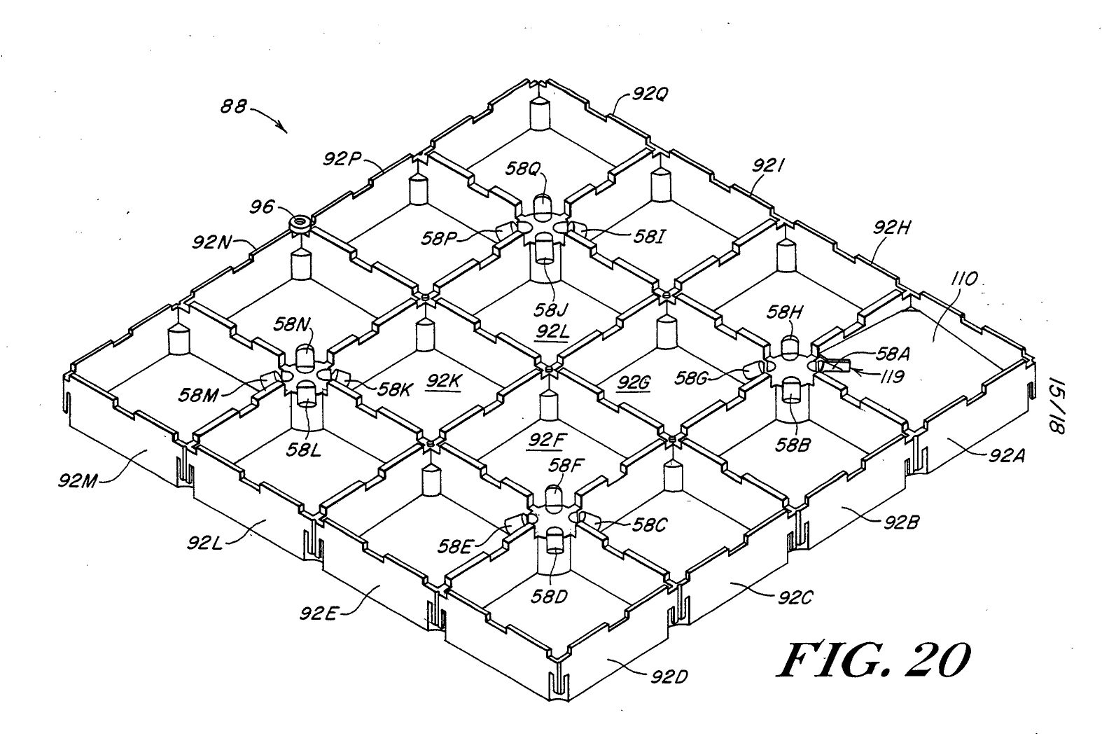

FIG. 20 provides a bottom view of the modular mid-portion 88. In more detail, the diffuser element 110 is inserted into the bottom portion of the pixel housing 92 as indicated by pixel housing 92A. Illumination element 58A fits through the opening 119 to illuminate the pixel housing 92A when enabled. FIG. 20 also illustrates the advantageous layout of the modular illuminable assembly 14 to minimize the length of the interconnections that are used to operate the modular illuminable assembly 14. Moreover, the configuration of the pixel housing 92 allows for interchangeable parts and significantly reduces the possibility of manufacturing errors during the manufacture of the modular illuminable assembly 14.

The illustrative embodiment of the present invention tracks the location of one or several physical objects relative to the modular illuminable assembly 14 (i.e.: the playing surface) of the illuminable modular system 10. The position of the physical object or objects is tracked by interpreting the data sent from the receivers located in the modular illuminable assembly 14 to the electronic device 16. Specifically, which receivers receive a signal from the physical object as opposed to which receivers do not receive a signal is used to determine the location of the physical object relative to the modular illuminable assembly 14.

In one embodiment, a physical object that is approximately the size of a standard computer mouse is affixed to the shoe of a user of the illuminable modular system 10. The physical object includes three signal transmitters located on the exterior edge of the physical object. The signal transmitters are located so as to project a signal away from the physical object. The three signal transmitters are positioned approximately equal distances away from each other so as to send signals out approximately every 120° around the exterior of the physical object. As the user moves relative to the modular illuminable assembly 14, the signal pattern also moves with different receivers receiving the signals generated by the signal transmitters. Additionally, the orientation of the physical object relative to the illuminable assembly impacts which receivers pick up a signal. For example, if a user is running and the toe of a shoe is pointing downwards, the third transmitter may generate a signal directly away from the modular illuminable assembly 14 which will not be picked up resulting in only two patterns picked up by the receivers of the illuminable assembly. Those skilled in the art will recognize that the number of signal transmitters may be more or less than the three transmitters described herein, and that the positioning of the signal transmitters on the physical object may vary without departing from the scope of the present invention.

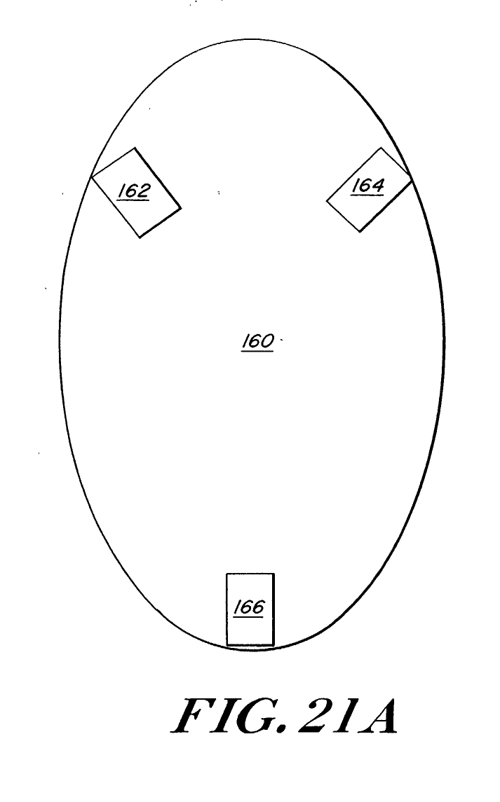

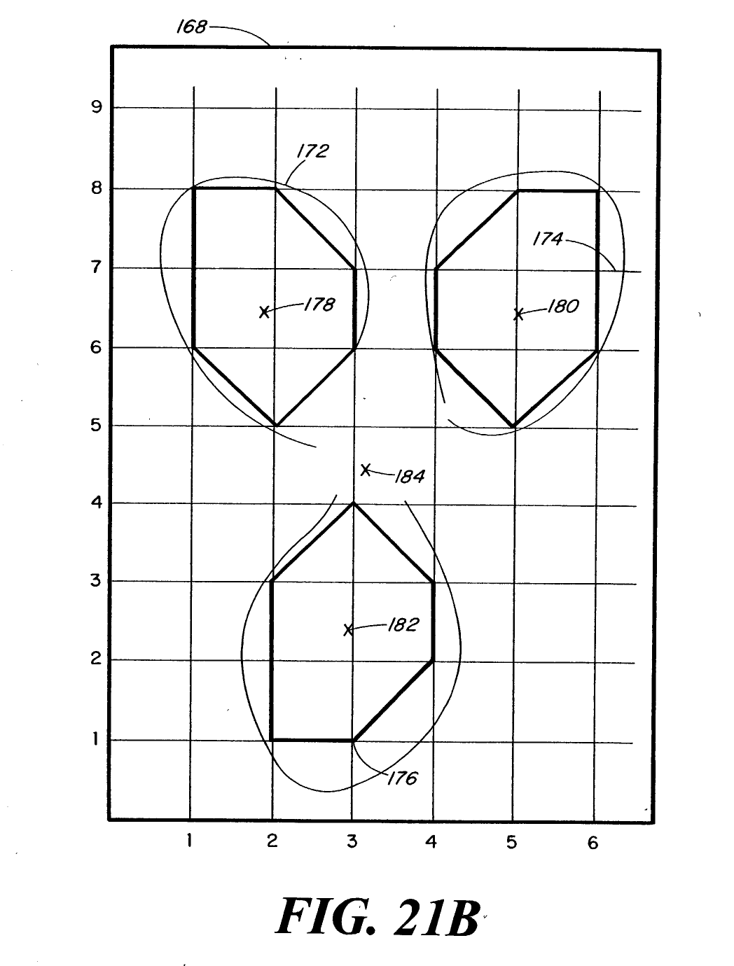

FIG. 21A depicts a physical object 160 about the size of a computer mouse. The physical object 160 includes signal transmitters 162, 164 and 166 which are spaced at approximately equal distances from each other around the exterior of the physical object 160. The signal transmitters 162, 164 and 166 generate signals directed away from the physical object 160 which are detected by receivers in the modular illuminable assembly 14.

The receivers on the modular illuminable assembly 14 that receive the signal from the transmitters 162, 164 and 166 inform the electronic device 16. The locations of the receivers that register a signal form a pattern on the modular illuminable assembly 14. The patterns are programmatically analyzed to produce an estimation of the physical object's current location and optionally an expected future course. The illustrative embodiment of the present invention also compares the signal ID with previous determined locations and parameters to verify the current location (i.e.: a physical object on a shoe cannot move greater than a certain distance over the chosen sampling time interval). The modular illuminable assembly 14 is mapped as a grid 168 marked by coordinates (see FIG. 21B below).

FIG. 21B depicts the grid 168 with three superimposed patterns 172, 174 and 176 that have been detected by the receivers of the modular illuminable assembly 14. Each receiver that registers the signal sent from the transmitters is plotted on the grid 168, with the pattern being formed by connecting the exterior receiver coordinates. Each adjacent exterior coordinate is connected to the next exterior coordinate by a line segment. The patterns in this case are all equal in size and density and are therefore produced by a physical object either on, or horizontally oriented to, the modular illuminable assembly 14. The patterns 172, 174 and 176 are analyzed to determine the centers 178, 180 and 182 of each of the patterns. The center of the patterns 178, 180 and 182 represent the center of the respective signal paths are utilized to determine the origin of the signal 184 (i.e.: the position of the physical object 160). Analog signal strength can also be used to enhance the estimation of the signal origin by using the physical principle that the strength will be greater closer to the signal source. In the present embodiment, a digital signal is used to reduce the need to process signal noise.

The illuminable modular system 10 determines the coordinates on the grid 168 of the receivers that receive the transmitters 162, 164 and 166 signal in order to establish a pattern. The process is similar to placing a rubber band around a group of nails protruding out of a piece of wood (with the position of the responding receivers corresponding to the nails). The rubber band forms a circumference pattern. Similarly, the receiver pattern is formed by drawing a line on the grid 168 connecting the coordinates of the exterior responding receivers. The adjacent exterior coordinates are connected by line segments. Some receivers within the pattern may not respond, perhaps due to a contestant in a game standing on the receiver and blocking the signal, or because of malfunction. For the purposes of determining the center of the pattern, non-responding receivers within the pattern are ignored. A weighted average of the external line segments is calculated in order to determine the center coordinates of the pattern. Longer line segments are given proportionally more weight. Once the center of the pattern 172 has been calculated, probability zones are established for a probability density function by computing the angles each exterior coordinate point makes from the center. A similar process is then followed to for the other patterns 174 and 176.

Following the calculation of the centers of the three patterns 172, 174 and 176, the center coordinates 178, 180 and 182 of the three patterns are averaged to make a rough prediction of the position of the physical object 160. This rough location prediction is then used in a sampling algorithm which tests a probability density function (pdf) of the object's location points in expanding concentric circles out from the rough prediction center point. The pdf is a function that has an exact solution given the physics of the signals involved and models of noise and other factors. Given enough computational power, an optimal pdf can be computed.

In the present embodiment, approximations are used to make the computation more efficient. The following approximations and models are used in the present embodiment. Using the probability zones already computed, a sample point is first categorized into a zone by examining the vector angle the point makes with respect to the pattern center. Next, it is determined whether the point lies within the bounding pattern circumference. If the point is located within the bounding pattern circumference, a much smaller variance value is used in computing a normal probability density function that drops off as the sample point to line segment distance increases. This function represents the ideal physical principle that the signal source is most likely to be close to the edge of the signal pattern. If the signal source were farther away, additional receivers would have seen the signal, and if the signal source was closer in to the center of the pattern, the signal would have to travel backwards. Since it is assumed there is noise in the environment, this physical principle is modeled noisily using a probabilistic approach. This algorithm also assumes a directional signal, and the direction of the signal implies an orientation angle to the physical object. Given an established probability zone, the sample point to pattern center angle is used as an additional probability factor in estimating object orientation angle. The probability function drops off as the possible orientation angle differs from the sample point to pattern center angle. Given multiple signal patterns, a sample point's pdf is computed for each pattern and multiplied together to compute an overall pdf. By using the fact that the physical object can have only one orientation angle, each pdf's orientation angle must be coordinated with the others (e.g., if the signal directions are 120 degrees apart, the angles used in the pdf must be 120 degrees apart). Either integrating over all possible angles or using just the average best angle may be used in computing the overall pdf.

The sampling algorithm multiplies the probability given the x and y center coordinates (which represent the distance from the edge of the modular illuminable assembly 14) and the angle between the center coordinates and the position of the physical object for the first pattern, by the probability given the x and y center coordinates and the angle between the center coordinates and the position of the physical object for the second and third patterns to get an overall value. When the sampling algorithm returns a value that is less than 1% of the highest value seen so far after exploring a minimum number of sampling rings, it stops and the highest value or pdf-weighted average of a set of highest values is chosen as the x, y coordinates representing the position of the physical object 160. Those skilled in the art will recognize that once a final position has been calculated for the physical object 160, it may be further verified by resorting to additional information including the historical position of the physical object and pressure readings from pressure sensors embedded in the floor of the modular illuminable assembly. In an alternative embodiment, the location may be calculated solely from pressure readings, accelerometer readings, or a combination or receiver patterns, accelerometer readings, historical data and pressure readings, or gyroscope readings. Further, each of these pieces of information imply a pdf on locations for the object, and may be multiplied together when available in a similar algorithm to that described for the directional signal algorithm to achieve a final probabilistic estimation.

Once a final position has been determined, the orientation of the physical object 160 is calculated. The orientation is calculated utilizing a number of factors either alone or in combination including the known range of the transmitters, the receiving abilities of the receivers, accelerometer readings from an accelerometer attached to the physical object 160, gyroscope readings from a gyroscope attached to the physical object, and the width of the transmitted signal. The orientation calculation determines the relative probability that the physical object is oriented in a particular position by testing orientation values capable of producing the detected patterns.

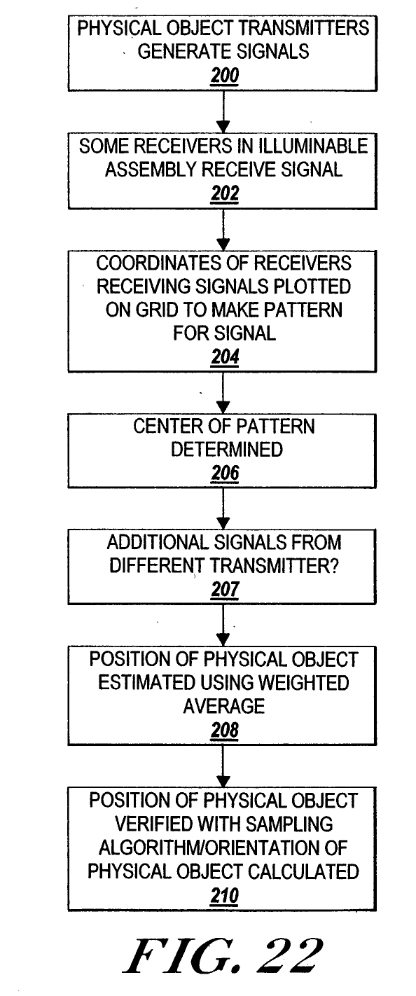

The sequence of steps followed by the illustrative embodiment of the present invention is depicted in the flowchart of FIG. 22. The sequence begins when the physical object transmitters on a physical object generate signals (step 200). Some of the receivers in the illuminable assembly receive the signals (step 202) and report the signal to the electronic device 16. The surface of the modular illuminable assembly 14 is represented as a grid 168 and coordinates corresponding to the location of the receivers detecting signals are plotted on the grid (step 204). Each signal is identified by a physical object ID and transmitter ID and the coordinates form a pattern when mapped on the grid 168. The center of the signal pattern is determined as discussed above (step 206). If more than one signal is detected (step 207) the process iterates until centers of each pattern have been determined. A weighted average is then applied to estimate an overall source of the signal corresponding the position of the physical object 160 (step 208). Error checking may be performed to determine the accuracy of the predicted position by using historical data and comparing predictions based on parameters (i.e.: a runner doesn't travel 50 yards in one second and a left and right shoe object should not be separated by 15 feet). Once the position of the physical object 160 has been roughly estimated, a pdf sampling algorithm is applied starting at the rough estimate to more accurately estimate the position and the orientation of the physical object to the modular illuminable assembly (step 210). A combination of accelerometer readings, historical data, pressure readings, gyroscope readings or other available location data may also be used to provide additional parameters to the pdf for more accuracy.

The illuminable modular system 10 tracks the current location of the physical object 160 so that it can reference the location of the physical object when sending commands to the modular illuminable assembly 14. The commands may be instructions for the generation of light displays by LED's embedded in the modular illuminable assembly 14. The commands sent from the electronic device 16 via the transmitters may include instructions for the generation of light at the current location of the physical object 160 or at a location offset from the current location of the physical object. The light display may be white light or a colored light with the color indicated in a separate field in the command (i.e. separate command fields for the red, blue and green diodes in an RGB diode which hold instructions for the signal intensity for each separate colored diode). Alternatively, the commands sent from the electronic device may relate to the generation of audio effects by different portions of the modular illuminable modular system 10 relative to the current location of the physical object 160. For example, during a game, the modular illuminable assembly may emit sound with each step of a player wearing the physical object 160. Alternatively, the game may require the player to change direction in response to sounds emanating from a remote region of the modular illuminable assembly 14. A physical object attached to a ball (or a ball which is the physical object) may cause the generation of noise or light shadowing the path of the ball as the ball is thrown above the surface of the modular illuminable assembly 14.

In another embodiment, the position of the physical object 160 is determined based upon the strength of the signal received by the receivers in the modular illuminable assembly 14. The position of the physical object 160 is triangulated by comparing the signal strength from different receivers. Those skilled in the art will recognize that are a number of ways in which the illustrative embodiment of the present invention may determine the current location of the physical object 160. The physical object 160 may contain only one or two signal transmitters instead of three transmitters. The signal transmitters may be arranged in different orientations that are not equidistant from each other on the physical object 160 so as to create special patterns among the receivers that are recognizable by the electronic device. Additionally, the physical object 160 may be larger or smaller than the examples given herein without departing from the scope of the present invention.

In one embodiment of the present invention, the location of the physical object 160 is determined solely through the use of pressure sensors in the modular illuminable assembly 14. Sensors in the modular illuminable assembly 14 report pressure changes to the electronic device 16. A clustering algorithm determines the location of the physical object 160 by grouping pressure reports into clusters of adjacent coordinates. The coordinates are sorted from readings of the most pressure to the least pressure. The pressure readings are then examined sequentially, starting with the highest pressure reading. If the pressure reading is next to an existing cluster, it is added to the cluster. Otherwise, the pressure reading is used to start a new cluster, until all readings have been passed through. The physical principle underlying this algorithm is that a single pressure source will result in strictly monotonically decreasing pressure readings away from the center of the pressure source. Therefore, if pressure readings decrease and then increase along a collinear set of sensors, it must be caused by more than one pressure source. An assumption is made that a foot is not more than 16 inches long, so that if the cluster spans more than three grid coordinates it is assumed that it represents more than 1 foot. The pressure readings for each cluster are added to get total weight being applied to the cluster. The total weight serves as an indicator as to whether the physical object 160 is landing, rising or staying still. Those skilled in the art will recognize that the pressure clustering algorithm may also be used in combination with other location methods including those outlined above rather than as the only location procedure. Additionally, these pressure location estimations are used to coordinate the location estimations of the device described previously with the state of the device or device-connected limb applying pressure or not to the surface. The pressure location technology may be also employed by itself as a basis for applications that do not require the tracking device at all, but rather only the applied pressure to the surface by the user or other objects.

While the present invention has been described with reference to a preferred embodiment thereof, one of ordinary skill in the art will appreciate that various changes in form and detail may be made without departing from the intended scope of the present invention as defined in the pending claims. For example, the illuminable assembly can be configured to use less than 16 pixels or that each illuminable assembly can be utilized in a star topology or a bus topology or even coupled to a hub or router to increase the playing surface of the entertainment system.

In the claims:

1. An illuminable system capable of interacting with one or more users, the illuminable system comprising:
a physical object capable of transmitting data to at least a portion of the illuminable system;
an electronic device suitable for controlling operation of the illuminable system, the operation of the illuminable system based in part on the data transmitted by the physical object; and
a modular illuminable assembly in communication with the electronic device and the physical object, the modular illuminable assembly providing the electronic device with the data transmitted from the physical object and data generated by the modular illuminable assembly, the modular illuminable assembly being capable of providing a response to data from the electronic device for entertaining the one or more users.

2. The illuminable system of claim 1, further comprising a transmitter module to allow the electronic device to communicate with the physical object to allow the electronic device to control a portion of the physical object.

3. The illuminable system of claim 1, wherein the physical object comprises a transducer.

4. The illuminable system of claim 3, wherein the transducer comprises a device selected from at least one of an accelerometer, an inclinometer, an audio transducer, a gyroscope, and a compass.

5. The illuminable system of claim 3, wherein the physical object is capable of transmitting a data packet, the data packet holding information that identifies the physical object, transducer data and error detection information.

6. The illuminable system of claim 5, wherein the transducer data comprises, data from one or more accelerometers to indicate an acceleration value of the physical object.

7. The illuminable system of claim 5, wherein the transducer data comprises, data from one or more gyroscopes to indicate a position of the physical object.

8. The illuminable system of claim 5, wherein the transducer data comprises, data from one or more inclinometers to indicate a position of the physical object.

9. The illuminable system of claim 3, wherein the physical object further comprises an illumination source to illuminate the physical object in a selected color.

10. The illuminable system of claim 1, wherein the electronic device comprises a device that responds to a set of instructions in a well-defined manner, the electronic device having at least one integrated circuit.

11. The illuminable system of claim 1, wherein the physical object is attachable to each of the one or more users.

12. The illuminable system of claim 1, wherein the physical object is integrated into one or more goods.

13. The illuminable system of claim 1, wherein the modular illuminable assembly is capable of supporting at least one of the one or more users when stepped on by the at least one user.

14. The illuminable system of claim 1, wherein the modular illuminable assembly is capable of being attached to a wall.

15. The illuminable system of claim 1, wherein the modular illuminable assembly comprises,
a receiver to receive the data transmitted by the physical object;
a pixel assembly to illuminate at least a portion of the modular illuminable assembly; and
an interface to the electronic device for transfer of data between the modular illuminable assembly and the electronic device.

16. The illuminable system of claim 15, further comprises a second interface for transfer of power between the modular illuminable assembly and a power source.

17. The illuminable system of claim 15, wherein the modular illuminable assembly further comprises, a pressure sensor assembly to sense a force exerted on a portion of the modular illuminable assembly.

18. The illuminable system of claim 15, wherein the modular illuminable assembly further comprises a loudspeaker assembly to allow the modular illuminable assembly to generate sounds for entertaining the one or more users.

19. The illuminable system of claim 15, wherein the modular illuminable assembly further comprises a controller circuit in communication with the interface for control of the pixel assembly.

20. The illuminable system of claim 15, wherein the pixel assembly comprises,
an illumination source to illuminate the pixel assembly; and
a housing to house the illumination source.

21. The illuminable system of claim 20, wherein the housing comprises a reflective element to diffuse illumination from the illumination source.

22. The illuminable system of claim 21, wherein the housing further comprises,
base portion adapted to fit over the illumination source;
a top portion adapted to form a portion of a receiver housing; and
a plurality of side portions coupled to the top portion to form the open base portion and the portion of the receiver housing, the plurality of side portions adapted to accept a fastening device to couple the housing to a base portion of the modular illuminable assembly.

23. The illuminable system of claim 15, wherein the modular illuminable assembly further comprises,
a mechanical interface to mechanically couple the modular illuminable assembly to a second modular illuminable assembly; and
an electrical interface to allow the modular illuminable assembly to communicate with the second modular illuminable assembly.

24. The illuminable system of claim 1, wherein the physical object is capable of transmitting data to at least a portion of the illuminable system in a wireless manner.

25. The illuminable system of claim 1, wherein the physical object is capable of transmitting data to at least a portion of the illuminable system in a manner using one or more energy conductors.

26. In a system capable of interacting with an individual, a method for interacting with the individual, the method comprising the steps of,
receiving data from a physical object in a wireless manner to determine at least a position of the physical object, the physical object having a unique role for identification of the physical object; and
illuminating one or more illumination sources based in part on the position of the physical object to interact with the individual.

27. The method of claim 26, further comprising the step of instructing the one or more illumination sources to illuminate without receiving data from the physical object.

28. The method of claim 26, further comprising the step of, determining a velocity of the physical object from transducer data transmitted by the physical object.

29. The method of claim 28, further comprising the step of, illuminating one or more of illumination sources based in part on the velocity of the physical object.

30. The method of claim 26, further comprising the steps of,
sensing a presence of the individual on a portion of one or more of the illumination sources at least a location of the individual; and
determining the presence of the individual on the portion of one or more of the illumination sources and the data from the physical object associated with the individual.

31. The method of claim 26, further comprising the step of, generating a sound to interact with the individual.

32. The method of claim 26, further comprising the step of generating a sound based in part on the position of the physical object to interact with the individual.

33. The method of claim 26, further comprising the step of, predicting a future position of the physical object based on the data from the physical object.

34. The method of claim 33, further comprising the step of, illuminating one or more of the illumination sources based in part on the predicted future position of the physical object.

35. A movement transducer for providing a response to a stimulus, the response indicating an acceleration value of the movement transducer, the movement transducer comprising,
a control circuit to control operation of the movement transducer, the control circuit capable of communicating with at least one other electronic device for indicating the response to the stimulus; and
a sensor circuit to sense the stimulus and provide the control circuit with an output signal, the output signal providing the control circuit with data for use in indicating the response to the stimulus.

36. The movement transducer of claim 35, further comprising a vibrator circuit in communication with the control circuit to cause the movement transducer to vibrate when the control circuit enables the vibrator circuit.

37. The movement transducer of claim 35, further comprising a sound circuit in communication with the control circuit, the sound circuit capable of outputting a sound when enabled by the control circuit.

38. The movement transducer of claim 35, further comprising an illumination circuit in communication with the control circuit, the illumination circuit capable of illuminating at least a portion of the movement transducer when enabled by the control circuit.

39. The movement transducer of claim 35, wherein the control circuit comprises,
a first interface circuit to receive data from the at least one other electronic device;
a controller to process the data received by the first interface circuit and the output signal generated by the sensor circuit; and
a second interface circuit to transmit data from the controller, the transmitted data providing the response indicating the acceleration value of the movement transducer.

40. The movement transducer of claim 39, wherein the first interface circuit comprises a receiver capable of receiving data in a wireless manner.

41. The movement transducer of claim 39, wherein the second interface circuit comprises a transmitter capable of transmitting data in a wireless manner.

42. The movement transducer of claim 35, wherein the sensor circuit comprises,
an accelerometer circuit capable of providing a tri-axes accelerometer output.

43. The movement transducer of claim 42, wherein the accelerometer circuit is capable of measuring both dynamic acceleration and static acceleration.

44. The movement transducer of claim 25, further comprising a housing to house the control circuit and the sensor circuit.

45. The movement transducer of claim 44, wherein the housing is selected from one of a molded housing, a waterproof housing, an impact resistant housing, an article of clothing, an article of footwear, and an article of sporting goods.

46. A method for controlling operation of a physical object capable of generating an output to stimulate a human being, the physical object communicating with an electronic device in a wireless manner, the method comprising the steps of,
transmitting a first data set from the physical object to the electronic device, the first data set indicating an acceleration value of the physical object in at least one of three axes the three-axes corresponding to an x-axis, a y-axis and a z-axis; and
transmitting a second data set from the electronic device to the physical object, the second data set providing the physical object with data to enable the physical object to generate the output to stimulate the human being, the second data set containing data based on the acceleration value of the physical object.

47. The method of claim 46, further comprising the step of assigning the physical object an identification.

48. The method of claim 46, wherein the physical object generates a vibrational output to stimulate the human being.

49. The method of claim 46, wherein the physical object generates a visual output to stimulate the human being.

50. The method of claim 46, wherein the physical object generates an audible output to stimulate the human being.

51. The method of claim 46, further comprising the step of, processing data from the first data set to determine a velocity value for the physical object.

52. The method of claim 46, further comprising the step of, processing data from the first data set to determine a distance value for the physical object relative to a reference point.

53. An apparatus for providing at least one sensory stimulus to at least one human sense of an individual, the apparatus comprising,
an electronic assembly capable of generating the at least one sensory stimulus, the electronic assembly in communication with one or more electronic devices to control generation of the at least one sensory stimulus, and the electronic assembly capable of supporting the individual when the individual steps onto the electronic assembly.

54. The apparatus of claim 53, wherein the electronic assembly further comprises,
a modular mid portion of one or more modules, each of the modules in the modular mid portion having an open bottom portion to receive a portion of a sensory stimulation circuit;
a top portion in contact with a portion of the modular mid portion to prevent damage to the modular mid portion when the individual steps onto the electronic assembly; and
a base portion coupled to at least one side portion of each of the modules in the modular mid portion, the base portion having an interface circuit and a sensory stimulation circuit mounted thereto, the interface circuit allowing the electronic assembly to communicate with the one or more electronic devices and the sensory stimulation circuit generating the at least one sensory stimulus based on data from the one or electronic devices.

55. The apparatus of claim 54, wherein each of the modules in the modular mid portion further comprises a diffuser element to assist in distributing illumination generated by the sensory stimulation circuit.

56. The apparatus of claim 54, wherein each of the modules in the modular mid portion further comprise, a top portion adapted to house a portion of a sensor, the sensor capable of receiving data from the one or more electronic devices.

57. The apparatus of claim 56, wherein the top portion of each of the modules in the modular mid portion are further adapted to house a portion of a second sensor, the second sensor in communication with the sensory stimulation circuit to provide an input that indicates a force value exerted on at least a portion of the top portion.

58. The apparatus of claim 54, wherein the sensory stimulation circuit comprises,
an illumination source to illuminate at least one of the modules in the modular mid portion to generate a sensory stimulus.

59. The apparatus of claim 58, wherein the sensory stimulation circuit further comprises, a control circuit to control operation of the illumination source, the control circuit coupled to the interface circuit to communicate with the one or more electronic devices, the control circuit and the one or more electronic devices communicating data to control illumination of the illumination source.

60. The apparatus of claim 58, wherein the sensory stimulation circuit further comprises, a loudspeaker circuit to change electrical signals from the control circuit in to sounds to generate a sensory stimulus.

61. The apparatus of claim 58, wherein the sensory stimulation circuit further comprises, a sensor circuit to receive data in a wireless manner from one or more of the electronic devices, the data received by the sensor indicates at least a present position of the individual relative to the electronic assembly.

62. The apparatus of claim 58, wherein the sensory stimulation circuit further comprises, a second sensor circuit to sense a pressure value transmitted onto a portion of the apparatus, the pressure value providing an indication of at least one individual in substantial contact with the apparatus.

63. The apparatus of claim 54, wherein the interface circuit comprises,
a first controller interfacing with the sensory stimulation circuit to coordinate generation of the one or more sensory stimuli; and
a second controller interfacing with one or more of the electronic assemblies and one or more of the electronic devices to allow the one or more electronic assemblies to be configured as a network.

64. In a system, a method, comprising the steps of:
providing a physical object equipped with at least one signal transmitter;
providing a surface equipped with a plurality of receivers capable of detecting signals from said at least one signal transmitter, said surface further equipped with a plurality of display components;
receiving a signal from said at least one signal transmitter with at least one of said receivers;
calculating a position of said physical object relative to said plurality of receivers based upon said signal; and
generating a display signal with at least one of said display components based on the calculated position of said physical object.

65. The method of claim 64, comprising the further steps of:
receiving said signal from at least one signal transmitter with a plurality of said receivers;
determining a pattern formed on said surface by said plurality of receivers receiving said signal, and
calculating said position of said physical object using the center of said pattern.

66. The method of claim 65, comprising the further steps of:
representing said surface as a grid with each position of said plurality of receivers on said grid corresponding to a set of coordinates;
calculating the orientation of said physical object relative to said surface by applying a probability density function to the coordinates corresponding to the locations of the plurality of receivers receiving said signal.

67. The method of claim 66 wherein said position is calculated to include a third dimension relative to said surface.

68. The method of claim 66, comprising the further steps of:
providing at least one additional physical object equipped with a signal transmitter;
calculating a position for said at least one additional physical object relative to said plurality of receivers based upon said signal; and
generating a display signal with at least one of said display components based on the calculated position of said at least one additional physical object.

69. The method of claim 68 wherein the position calculated for said at least one additional physical object includes a third dimension relative to said surface.

70. The method of claim 64 wherein said display signal is the emitting of a light, said light being any one of a plurality of colors.

71. The method of claim 70 wherein said signal display components are light emitting diodes.

72. The method of claim 64 wherein said position is calculated based upon the strength of the received signal.

73. The method of claim 64, comprising the further steps of:
receiving said signal from at least one signal transmitter with a plurality of said receivers;
determining the strength of the received signal at each of the plurality of receivers, and
calculating said position of said physical object based on the relative strength of signals at each of the plurality of receivers receiving said signal.

74. In a system, a method, comprising the steps of:
providing a physical object equipped with three signal transmitters, said signal transmitters oriented so as to emit signals away from said physical object, said signal transmitters approximately equidistant from each other on said physical object;
providing a surface equipped with a plurality of receivers capable of detecting signals from the three signal transmitters, said surface further equipped with a plurality of display components;
receiving signals from at least one of said three signal transmitters with a plurality of said receivers;
calculating a position of said physical object relative to said plurality of receivers based upon said signals; and
generating a display signal with at least one of said display components based on the calculated position of said physical object.

75. The method of claim 74, comprising the further steps of:
receiving said signal from at least one signal transmitter with a plurality of said receivers;
determining a pattern formed on said surface by said plurality of receivers receiving said signal, and
calculating said position of said physical object using the center of said pattern.

76. The method of claim 75, comprising the further steps of:
representing said surface as a grid with each position on said grid corresponding to a set of coordinates;
calculating the orientation of said physical object by applying a probability density function to the coordinates corresponding to the locations of the plurality of receivers receiving said signal.

77. The method of claim 74, comprising the further steps of:
receiving said signal from more than one of said three signal transmitters with a plurality of said receivers;
determining patterns formed on said surface by said plurality of receivers receiving said signal;
calculating the center of each of said patterns; and
determining a weighted average of the centers of each said pattern, said weighted average indicating the position of said physical object.

78. The method of claim 77, comprising the further steps of:
representing said surface as a grid with each position on said grid corresponding to a set of coordinates;
calculating the orientation of said physical object relative to said surface by applying a probability density function to the coordinates corresponding to the locations of the plurality of receivers receiving said signals.

79. The method of claim 78 wherein said final position is calculated to include a third dimension relative to said surface.

80. The method of claim 79, comprising the further steps of:
providing at least one additional physical object equipped with a signal transmitter;
calculating a position for said at least one additional physical object relative to said plurality of receivers based upon said signal; and
generating a display signal with at least one of said display components based on the calculated position of said at least one additional physical object.

81. In a system, a medium holding computer-executable steps for a method, said method comprising the steps of:
providing a physical object equipped with at least one signal transmitter;
providing a surface equipped with a plurality of receivers capable of detecting signals from said at least one signal transmitter, said surface further equipped with a plurality of display components;
receiving a signal from said at least one signal transmitter with at least one of said receivers;
calculating a position of said physical object relative to said plurality of receivers based upon said signal; and
generating a display signal with at least one of said display components based on the calculated position of said physical object.

82. The medium of claim 81, wherein said method comprises the further steps of:
receiving said signal from at least one signal transmitter with a plurality of said receivers;
determining a pattern formed on said surface by said plurality of receivers receiving said signal, and
calculating said position of said physical object using the center of said pattern.

83. The medium of claim 82, wherein said method comprises the further steps of:
representing said surface as a grid with each position of said plurality of receivers on said grid corresponding to a set of coordinates;
calculating the orientation of said physical object relative to said surface by applying a probability density function to the coordinates corresponding to the locations of the plurality of receivers receiving said signal.

84. A system capable of rendering one or more colors selected from a spectrum of colors, the system comprising:
an electronic device suitable for controlling operation of the system; and
one or more illuminable assemblies coupled in a manner to so that each of the one or more illuminable assemblies communicates with the electronic device to allow the one or more illuminable assemblies to render the one or more colors selected from the spectrum of colors in accordance with instructions from the electronic device, each of the one or more illuminable assemblies comprising,
a controller for communicating with another one of the illuminable assemblies and with the electronic device;
a sensor circuit for detecting a location of at least one user of the system; and
one or more illumination sources capable of illuminating the illuminable assembly in the one or more colors selected from a spectrum of colors.

85. The system of claim 84, wherein the sensor circuit comprises, a pressure sensor circuit responsive to a force, wherein the force is provided by the at least one user.

86. The system of claim 83, further comprising a physical object capable of communicating with each of the one or more illuminable assemblies, the physical object providing the one or more illuminable assemblies with an indication of a location of the physical object.

87. The system of claim 86, wherein each of the one or more illuminable assemblies further comprise a communication circuit responsive to a signal transmitted by the physical object, the communication circuit communicates with the controller to provide the controller with information concerning the physical object.

88. The system of claim 85, wherein the pressure sensor circuit comprises,
an inductor; and
a magnet moveable in at least a first direction relative to the inductor in response to the force, wherein movement of the magnet in the at least first direction relative to the inductor influences a frequency value of a signal propagating through the inductor so that the pressure sensor generates a response to the force in accordance with the altered frequency value of the signal propagating through the inductor.

89. A movement transducer for providing a response to a stimulus, the response indicating a position of the movement transducer, the movement transducer comprising,
a control circuit to control operation of the movement transducer, the control circuit capable of communicating with at least one other electronic device for indicating the response to the stimulus; and
a sensor circuit to sense the stimulus and provide the control circuit with an output signal, the output signal providing the control circuit with data for use in indicating the response to the stimulus.

90. The movement transducer of claim 89, further comprising a vibrator circuit in communication with the control circuit to cause the movement transducer to vibrate when the control circuit enables the vibrator circuit.

91. The movement transducer of claim 89, further comprising a sound circuit in communication with the control circuit, the sound circuit capable of outputting a sound when enabled by the control circuit.

92. The movement transducer of claim 89, further comprising an illumination circuit in communication with the control circuit, the illumination circuit capable of illuminating at least a portion of the movement transducer when enabled by the control circuit.

93. The movement transducer of claim 89, wherein the sensor circuit comprises a gyroscope.

94. The movement transducer of claim 93, wherein the gyroscope provides angular data concerning the location of the movement transducer.
